(19) United States
(12) Patent Application Publication
(10) Pub. No.: US 2026/0175202 A1
(43) Pub. Date: Jun. 25, 2026

(54) CATALYTIC MEMBRANE AND REACTORS COMPRISING THE SAME

(71) Applicants: W. L. Gore & Associates, Inc., Newark, DE (US); ZAIPUT FLOW TECHNOLOGIES LLC, Waltham, MA (US)

(72) Inventors: JOHN HOLCOMBE, Newark, DE (US); VLADIMIROS NIKOLAKIS, Newark, DE (US); JOHN SQUERI, Newark, DE (US); JEFFREY KNOPF, Newark, DE (US); STEPHEN STARK, Newark, DE (US); JAMES MANNINO, Newark, DE (US); ANDREA ADAMO, Waltham, MA (US); LORENZO MILANI, Waltham, MA (US); COLIN PATRICK O'SHEA, Waltham, MA (US)

(73) Assignees: W. L. Gore & Associates, Inc., Newark, DE (US); ZAIPUT FLOW TECHNOLOGIES LLC, Waltham, MA (US)

(21) Appl. No.: 19/125,784

(22) PCT Filed: Oct. 30, 2023
(86) PCT No.: PCT/US2023/078152

§ 371 Date: Apr. 30, 2025

Related U.S. Application Data
(60) Provisional application No. 63/381,595, filed on Oct. 31, 2022.

(51) Int. Cl. B01J 23/83; B01D 53/94; B01J 19/00; B01J 37/00

(52) U.S. Cl. CPC B01J 23/83; B01D 53/945; B01J 19/0093; B01J 37/0018; B01J 2208/00752; B01J 2219/00835

(57) ABSTRACT

There is provided a catalytic membrane comprising at least one porous catalytic fluoropolymer film comprising catalyst particles enmeshed within a fluoropolymer matrix, wherein the catalytic membrane is configured to be suitable for use in a flow through reactor where substantially all of the reactant flowing through the reactor flows through the catalytic membrane following a tortuous pathway.

### FIELD

The disclosure relates to the field of catalytic membranes and reactors comprising the same, specifically to catalytic membranes that are particularly suitable for use in flow through reactors.

### BACKGROUND

Continuous Flow Reactors (CFR) are types of chemical reactors that provide excellent control of heat and mass transfer and are primarily suited for single or multi-phase flows for non-catalytic reactions or for reactions that are catalyzed by homogeneous catalysts.

Implementing CFRs for reactions that are catalyzed by heterogeneous supported catalysts (i.e. precious metals deposited on activated carbon, alumina, other supports, etc.) has many challenges. Flowing solid slurry solution is typically limited to a maximum of about 10% solids due to pumping limitations. Furthermore, separating the solids from the reaction mixture requires the use of an additional step.

The use of a packed bed with fine powder catalyst particles may result in prohibitively high pressure drops, and in certain cases can suffer from undesirable temperature variations (i.e. hot spots). The use of a packed bed with catalyst beads or pellets reduces the pressure drop (compared to powders) but does introduces issues related to channeling, packing uniformity, and heat and mass transport limitations in the pellet.

Furthermore, if a reaction is currently run using a fine powder in batch slurry, switching that reaction to a packed bed using a bead/pellet configuration might require re-validation of the catalyst support since it might not have the same textural and chemical properties as that of the original powder.

Accordingly, alternative configurations of CFRs are required that avoid the disadvantages of configurations in the art.

Some alternative configurations of CFRs use catalytic particles that are supported in different ways and in different parts of the flow path of reactants. For example, catalytic particles may be provided on a porous support that is oriented into the flow path of a CFR such that reactants flow past the porous support and so have the opportunity to contact the catalytic particles to thereby react to produce the desired product.

However, these alternative configurations still suffer from limited contact time of the reactant with the catalytic particles and often require many porous supports to be provided in sequence or parallel to thereby maximise the amount of reactant that contacts the catalytic particles, increasing the amount of catalyst that is required and so increasing the cost of the CFR accordingly.

Therefore, aspects of the present disclosure aim to address at least some of the above problems.

### SUMMARY

According to a first aspect there is provided a catalytic membrane comprising at least one porous catalytic fluoropolymer film comprising catalyst particles enmeshed within a fluoropolymer matrix, wherein the catalytic membrane is configured to be suitable for use in a flow through reactor where substantially all of the reactant flowing through the reactor flows through the pores of the porous catalytic fluoropolymer film.

In some embodiments the fluoropolymer matrix may have a fibrillated microstructure. The at least one porous catalytic polymer film may have a non-fibrillated microstructure.

In some embodiments, the catalytic membrane may be configured to be suitable for use in a flow through reactor where substantially all of the reactant flowing through the reactor flows through the catalytic membrane following a tortuous pathway.

The catalytic membrane may have an air flow resistivity of from about 1×10⁹ Pa s/m² to about 1×10⁴ Pa s/m². The catalytic membrane may have an air flow resistivity of from about 1×10⁸ Pa s/m² to about 1×10⁴ Pa s/m². The catalytic membrane may have an air flow resistivity of from about 1×10⁷ Pa s/m² to about 1×10⁴ Pa s/m². The catalytic membrane may have an air flow resistivity of from about 1×10⁶ Pa s/m² to about 1×10⁴ Pa s/m².

The catalytic membrane may have an air flow resistivity of less than about 1×10⁹ Pa s/m². The catalytic membrane may have an air flow resistivity of less than about 1×10⁸ Pa s/m². The catalytic membrane may have an air flow resistivity of less than about 1×10⁷ Pa s/m². The catalytic membrane may have an air flow resistivity of less than about 1×10⁶ Pa s/m².

The catalytic membrane may have a total specific pore volume of from about 0.4 cc/g to about 2.5 cc/g. The catalytic membrane may have a total specific pore volume of from about 0.4 cc/g to about 2.0 cc/g. The catalytic membrane may have a total specific pore volume of from about 0.4 cc/g to about 1.5 cc/g. The catalytic membrane may have a total specific pore volume of from about 0.4 cc/g to about 1.0 cc/g. The catalytic membrane may have a total specific pore volume of from about 0.6 cc/g to about 2.5 cc/g. The catalytic membrane may have a total specific pore volume of from about 0.8 cc/g to about 2.5 cc/g. The catalytic membrane may have a total specific pore volume of from about 1.0 cc/g to about 2.5 cc/g.

The catalytic membrane may have a total specific pore volume of from about 1.5 cc/g to about 2.5 cc/g.

The fluoropolymer may comprise polytetrafluoroethylene (PTFE).

The fluoropolymer may be an expanded fluoropolymer. For example, the fluoropolymer may be expanded PTFE (ePTFE).

In some embodiments where the at least one porous catalytic fluoropolymer film has a fibrillated microstructure the catalyst particles may be enmeshed within or between the fibrils of the fibrillated microstructure. The catalyst particles may be durably enmeshed within or between the fibrils of the fibrillated microstructure.

In some embodiments where the at least one porous catalytic fluoropolymer film has a non-fibrillated microstructure the catalyst particles may be enmeshed on the surface of the at least one porous catalytic fluoropolymer film or within the at least one porous catalytic fluoropolymer film.

The catalytic membrane may have a Brunauer, Emmett and Teller (BET) specific surface area of at least about 10 m²/g. The catalytic membrane may have a BET specific surface area of at least about 50 m²/g. The catalytic membrane may have a BET specific surface area of at least about 100 m²/g. The catalytic membrane may have a BET specific surface area of at least about 200 m²/g. The catalytic membrane may have a BET specific surface area of at least about 400 m²/g. The catalytic membrane may have a BET specific surface area of at least about 500 m²/g. The catalytic membrane may have a BET specific surface area of from about 10 m²/g to about 1250 m²/g. The catalytic membrane may have a BET specific surface area of from about 50 m²/g to about 1250 m²/g. The catalytic membrane may have a BET specific surface area of from about 100 m²/g to about 1250 m²/g. The catalytic membrane may have a BET specific surface area of from about 200 m²/g to about 1250 m²/g. The catalytic membrane may have a BET specific surface area of from about 400 m²/g to about 1250 m²/g. The catalytic membrane may have a BET specific surface area of from about 600 m²/g to about 1250 m²/g. The catalytic membrane may have a BET specific surface area of from about 800 m²/g to about 1250 m²/g.

The catalytic membrane may have a bulk density of from about 0.05 g/cm³ to about 3.0 g/cm³. The catalytic membrane may have a bulk density of from about 0.1 g/cm³ to about 3.0 g/cm³. The catalytic membrane may have a bulk density of from about 0.2 g/cm³ to about 3.0 g/cm³. The catalytic membrane may have a bulk density of from about 0.4 g/cm³ to about 3.0 g/cm³. The catalytic membrane may have a bulk density of from about 0.6 g/cm³ to about 3.0 g/cm³. The catalytic membrane may have a bulk density of from about 0.8 g/cm³ to about 3.0 g/cm³. The catalytic membrane may have a bulk density of from about 1.0 g/cm³ to about 3.0 g/cm³. The catalytic membrane may have a bulk density of from about 1.2 g/cm³ to about 3.0 g/cm³. The catalytic membrane may have a bulk density of from about 1.4 g/cm³ to about 3.0 g/cm³. The catalytic membrane may have a bulk density of from about 1.6 g/cm³ to about 3.0 g/cm³. The catalytic membrane may have a bulk density of from about 0.05 g/cm³ to about 2.0 g/cm³. The catalytic membrane may have a bulk density of from about 0.05 g/cm³ to about 1.8 g/cm³. The catalytic membrane may have a bulk density of from about 0.05 g/cm³ to about 1.6 g/cm³. The catalytic membrane may have a bulk density of from about 0.05 g/cm³ to about 1.4 g/cm³. The catalytic membrane may have a bulk density of from about 0.05 g/cm³ to about 1.2 g/cm³. The catalytic membrane may have a bulk density of from about 0.05 g/cm³ to about 1.0 g/cm³. The catalytic membrane may have a bulk density of from about 0.05 g/cm³ to about 0.8 g/cm³.

The catalytic particles may comprise a catalytic material. The catalytic material may comprise a catalytic metal. The catalytic metal may be a transition metal. For example the catalytic metal may be selected from the group platinum, palladium, rhodium, nickel, iridium, ruthenium, rhenium, silver, copper, chromium, iron, cobalt, nickel, zinc, manganese, zirconium, molybdenum or vanadium and alloys or combinations thereof. The catalytic material may be non-metallic. For example, the catalytic material may be activated carbon, oxides of metals such as aluminum oxide (Al₂O₃) and titanium dioxide (TiO₂), zeolites or mixed organic/inorganic materials like zeolitic imidazolate frameworks (ZIFs), and metal organic frameworks (MOFs).

The catalytic particles may comprise a carrier material. The catalytic material may be incorporated into a carrier material. The carrier material may be an oxide such as aluminum oxide (Al₂O₃), magnesium silicate (MgO:XSiO₂·H₂O), zirconia (ZrO₂), silica (SiO₂), zeolites or other metal oxides. The carrier material may be a non-metal such as carbon, activated carbon, or mixed organic/inorganic such as ZIFs and MOFs.

The catalytic particles may have a mean diameter of from 0.5 to 300 μm. The catalytic particles may have a mean diameter of from 0.5 to 250 μm. The catalytic particles may have a mean diameter of from 0.5 to 300 μm. The catalytic particles may have a mean diameter of from 0.5 to 200 μm. The catalytic particles may have a mean diameter of from 0.5 to 150 μm. The catalytic particles may have a mean diameter of from 1.0 to 300 μm. The catalytic particles may have a mean diameter of from 5 to 300 μm. The catalytic particles may have a mean diameter of from 10 to 300 μm. The catalytic particles may have a mean diameter of from 25 to 300 μm. The catalytic particles may have a mean diameter of from 50 to 300 μm. The catalytic particles may have a mean diameter of from 75 to 300 μm. The catalytic particles may have a mean diameter of from 100 to 300 μm.

The catalytic membrane may comprise at least 10 wt % (weight percentage or percentage by weight) catalytic particles. The catalytic membrane may comprise at least 20 wt %. The catalytic membrane may comprise at least 25 wt % catalytic particles. The catalytic membrane may comprise at least 30 wt % catalytic particles. The catalytic membrane may comprise at least 40 wt % catalytic particles. The catalytic membrane may comprise at least 50 wt % catalytic particles. The catalytic membrane may comprise at least 60 wt % catalytic particles. The catalytic membrane may comprise at least 70 wt % catalytic particles. The catalytic membrane may comprise at least 75 wt % catalytic particles. The catalytic membrane may comprise from 10 wt % to 90 wt % catalytic particles. The catalytic membrane may comprise from 20 wt % to 90 wt % catalytic particles. The catalytic membrane may comprise from 25 wt % to 90 wt % catalytic particles. The catalytic membrane may comprise from 30 wt % to 90 wt % catalytic particles. The catalytic membrane may comprise from 40 wt % to 90 wt % catalytic particles. The catalytic membrane may comprise from 50 wt % to 90 wt % catalytic particles. The catalytic membrane may comprise from 60 wt % to 90 wt % catalytic particles. The catalytic membrane may comprise from 70 wt % to 90 wt % catalytic particles. The catalytic membrane may comprise from 10 wt % to 80 wt % catalytic particles. The catalytic membrane may comprise from 20 wt % to 80 wt % catalytic particles. The catalytic membrane may comprise from 20 wt % to 70 wt % catalytic particles. The catalytic membrane may comprise from 20 wt % to 60 wt % catalytic particles. The catalytic membrane may comprise from 20 wt % to 50 wt % catalytic particles. The catalytic membrane may comprise from 20 wt % to 40 wt % catalytic particles.

The catalytic membrane may further comprise a support layer. The catalytic membrane may comprise a porous catalytic fluoropolymer film arranged on the support layer. The porous catalytic fluoropolymer film may be laminated to the support layer. The porous catalytic fluoropolymer film may be adhered to the support layer.

The support layer may not substantially impede the flow of fluid during use. The support layer may have a low resistance to fluid flow. The support layer may allow substantially free flow of fluid through the support layer. The support layer may comprise a plurality of apertures. Each aperture of the plurality of apertures may be sized so as to provide low resistance to fluid flow.

The support layer may comprise a mesh. The support layer may comprise a grid.

The support layer may be configured to not react with fluid flowing through the porous catalytic fluoropolymer film.

The support layer may comprise an inert material. The support layer may comprise an inert polymer material. The inert polymer material may comprise a fluoropolymer. The inert polymer material may comprise a polymer selected from the group comprising: polytetrafluoroethylene (PTFE), polyethylene (PE), polypropylene (PP), polyamide polyether sulfone (PES), polycarbonate, fluorinated ethylene propylene (FEP), polyvinylidene fluoride (PVDF). The inert polymer material may comprise polyethylene (PE), polypropylene (PP), nylon, cellulose based polymers, polyether sulfone (PES), or polycarbonate. The support layer may comprise an inert metal material. The inert metal may be selected from stainless steel, aluminium alloy, titanium alloy (Ti-6Al-4V), cobalt-chromium alloy (CoCr) or 316L stainless, Hastelloy, Inconel etc.). The support layer may comprise a metal oxide. The metal oxide may comprise aluminum oxide (Al₂O₃) or titanium dioxide (TiO₂). The support layer may comprise a porous material, such as a porous ceramic or a porous glass, for example.

The support layer may increase the strength of the catalytic membrane. The support layer may be configured to increase the resistance of the catalytic membrane to deformation due to pressure applied to the catalytic membrane by fluid impacting the porous catalytic fluoropolymer film during use. The support layer may be configured to increase the resistance of the catalytic membrane to damage due to pressure applied to the catalytic membrane by fluid impacting the porous catalytic fluoropolymer film during use.

The support layer may be provided on the side of the catalytic membrane that downstream during use. Accordingly, the support layer may be positioned to support the porous catalytic fluoropolymer film such that it may resist being deformed by pressure applied to the upstream surface of the catalytic membrane by fluid impacting that surface.

The catalytic membrane may have a thickness of from about 100 μm to about 2000 μm. The catalytic membrane may have a thickness of from about 100 μm to about 1800 μm. The catalytic membrane may have a thickness of from about 100 μm to about 1600 μm. The catalytic membrane may have a thickness of from about 100 μm to about 1400 μm. The catalytic membrane may have a thickness of from about 100 μm to about 1200 μm. The catalytic membrane may have a thickness of from about 100 μm to about 1000 μm. The catalytic membrane may have a thickness of from about 100 μm to about 800 μm. The catalytic membrane may have a thickness of from about 100 μm to about 600 μm. The catalytic membrane may have a thickness of from about 100 μm to about 500 μm. The catalytic membrane may have a thickness of from about 200 μm to about 2000 μm. The catalytic membrane may have a thickness of from about 300 μm to about 2000 μm. The catalytic membrane may have a thickness of from about 400 μm to about 2000 μm. The catalytic membrane may have a thickness of from about 500 μm to about 2000 μm.

It will be appreciated that in embodiments comprising a support layer that the thickness of the catalytic membrane may be greater than the thickness of catalytic membranes that do not comprise a support layer.

The catalytic membrane may comprise a plurality of porous catalytic fluoropolymer films. The catalytic membrane may comprise two porous catalytic fluoropolymer films. The catalytic membrane may comprise three porous catalytic fluoropolymer films. The catalytic membrane may comprise four porous catalytic fluoropolymer films. The catalytic membrane may comprise five porous catalytic fluoropolymer films.

The catalytic membrane may have a Young's Modulus of at least 0.1 MPa. The catalytic membrane may have a Young's Modulus of at least 1 MPa. The catalytic membrane may have a Young's Modulus of at least 10 MPa. The catalytic membrane may have a Young's Modulus of at least 50 MPa. The catalytic membrane may have a Young's Modulus of at least 100 MPa. The catalytic membrane may have a Young's Modulus of at least 200 MPa. The catalytic membrane may have a Young's Modulus of at least 500 MPa. The catalytic membrane may have a Young's Modulus of at least 750 MPa. The catalytic membrane may have a Young's Modulus of at least 1 GPa. The catalytic membrane may have a Young's Modulus of at least 10 GPa. The catalytic membrane may have a Young's Modulus of at least 20 GPa. The catalytic membrane may have a Young's Modulus of at least 50 GPa. The catalytic membrane may have a Young's Modulus of at least 100 GPa. The catalytic membrane may have a Young's Modulus of at least 200 GPa.

The catalytic membrane may have a Young's Modulus of from 0.1 MPa to 500 GPa. The catalytic membrane may have a Young's Modulus of from 1 MPa to 500 GPa. The catalytic membrane may have a Young's Modulus of from 10 MPa to 500 GPa. The catalytic membrane may have a Young's Modulus of from 50 MPa to 500 GPa. The catalytic membrane may have a Young's Modulus of from 100 MPa to 500 GPa. The catalytic membrane may have a Young's Modulus of from 200 MPa to 500 GPa. The catalytic membrane may have a Young's Modulus of from 500 MPa to 500 GPa. The catalytic membrane may have a Young's Modulus of from 750 MPa to 500 GPa. The catalytic membrane may have a Young's Modulus of from 1 GPa to 500 GPa. The catalytic membrane may have a Young's Modulus of from 10 GPa to 500 GPa. The catalytic membrane may have a Young's Modulus of from 20 GPa to 500 GPa. The catalytic membrane may have a Young's Modulus of from 50 GPa to 500 GPa. The catalytic membrane may have a Young's Modulus of from 100 GPa to 500 GPa. The catalytic membrane may have a Young's Modulus of from 500 MPa to 400 GPa. The catalytic membrane may have a Young's Modulus of from 500 MPa to 300 GPa. The catalytic membrane may have a Young's Modulus of from 500 MPa to 200 GPa. The catalytic membrane may have a Young's Modulus of from 500 MPa to 100 GPa. The catalytic membrane may have a Young's Modulus of from 500 MPa to 50 GPa. The catalytic membrane may have a Young's Modulus of from 500 MPa to 10 GPa. The catalytic membrane may have a Young's Modulus of from 500 MPa to 1 GPa.

The catalytic membrane may have a yield strength of at least about 0.1 MPa. The catalytic membrane may have a yield strength of at least about 0.5 MPa. The catalytic membrane may have a yield strength of at least about 1 MPa. The catalytic membrane may have a yield strength of at least about 1.5 MPa. The catalytic membrane may have a yield strength of at least about 2 MPa. The catalytic membrane may have a yield strength of at least about 5 MPa. The catalytic membrane may have a yield strength of at least about 10 MPa. The catalytic membrane may have a yield strength of at least about 15 MPa. The catalytic membrane may have a yield strength of at least about 20 MPa.

The catalytic membrane may have a yield strength of from about 0.1 MPa to about 20 MPa. The catalytic membrane may have a yield strength of from about 0.1 MPa to about 15 MPa. The catalytic membrane may have a yield strength of from about 0.1 MPa to about 10 MPa. The catalytic membrane may have a yield strength of from about 0.1 MPa to about 8 MPa. The catalytic membrane may have a yield strength of from about 0.1 MPa to about 6 MPa.

The catalytic membrane may have a yield strength of from about 0.1 MPa to about 4 MPa. The catalytic membrane may have a yield strength of from about 0.1 MPa to about 2 MPa. The catalytic membrane may have a yield strength of from about 0.5 MPa to about 20 MPa. The catalytic membrane may have a yield strength of from about 1 MPa to about 20 MPa. The catalytic membrane may have a yield strength of from about 2 MPa to about 20 MPa. The catalytic membrane may have a yield strength of from about 5 MPa to about 20 MPa. The catalytic membrane may have a yield strength of from about 10 MPa to about 20 MPa. The catalytic membrane may have a yield strength of from about 15 MPa to about 20 MPa.

The catalytic membrane may have a tensile strength of from about 0.1 MPa to about 20 MPa. The catalytic membrane may have a tensile strength of from about 0.1 MPa to about 15 MPa. The catalytic membrane may have a tensile strength of from about 0.1 MPa to about 10 MPa. The catalytic membrane may have a tensile strength of from about 0.1 MPa to about 8 MPa. The catalytic membrane may have a tensile strength of from about 0.1 MPa to about 6 MPa. The catalytic membrane may have a tensile strength of from about 0.1 MPa to about 4 MPa. The catalytic membrane may have a tensile strength of from about 0.1 MPa to about 2 MPa. The catalytic membrane may have a tensile strength of from about 0.5 MPa to about 20 MPa. The catalytic membrane may have a tensile strength of from about 1 MPa to about 20 MPa. The catalytic membrane may have a tensile strength of from about 2 MPa to about 20 MPa. The catalytic membrane may have a tensile strength of from about 5 MPa to about 20 MPa. The catalytic membrane may have a tensile strength of from about 10 MPa to about 20 MPa. The catalytic membrane may have a tensile strength of from about 15 MPa to about 20 MPa.

It will be appreciated that embodiments where the catalytic membrane comprises a support layer will typically have a higher tensile strength and yield strength than those embodiments where the catalytic membrane does not comprise a support layer.

The pressure drop across the catalytic membrane during use may be from 0.069 kPa (0.01 psi) to 2068 kPa (300 psi). The pressure drop across the catalytic membrane during use may be from 0.069 kPa to 2000 kPa. The pressure drop across the catalytic membrane during use may be from 0.069 kPa to 1750 kPa. The pressure drop across the catalytic membrane during use may be from 0.069 kPa to 1500 kPa. The pressure drop across the catalytic membrane during use may be from 0.069 kPa to 1250 kPa. The pressure drop across the catalytic membrane during use may be from 0.069 kPa to 1000 kPa. The pressure drop across the catalytic membrane during use may be from 0.069 kPa to 750 kPa. The pressure drop across the catalytic membrane during use may be from 0.069 kPa to 500 kPa. The pressure drop across the catalytic membrane during use may be from 0.069 kPa to 250 kPa. The pressure drop across the catalytic membrane during use may be from 0.1 kPa to 2068 kPa. The pressure drop across the catalytic membrane during use may be from 0.5 kPa to 2068 kPa. The pressure drop across the catalytic membrane during use may be from 1 kPa to 2068 kPa. The pressure drop across the catalytic membrane during use may be from 5 kPa to 2068 kPa. The pressure drop across the catalytic membrane during use may be from 10 kPa to 2068 kPa. The pressure drop across the catalytic membrane during use may be from 50 kPa to 2068 kPa. The pressure drop across the catalytic membrane during use may be from 100 kPa to 2068 kPa. The pressure drop across the catalytic membrane during use may be from 150 kPa to 2068 kPa. The pressure drop across the catalytic membrane during use may be from 200 kPa to 2068 kPa. The pressure drop across the catalytic membrane during use may be from 500 kPa to 2068 kPa. The pressure drop across the catalytic membrane during use may be from 1000 kPa to 2068 kPa. The pressure drop across the catalytic membrane during use may be from 1500 kPa to 2068 kPa.

The pressure drop across the catalytic membrane during use may be less than 2000 kPa. The pressure drop across the catalytic membrane during use may be less than 1500 kPa. The pressure drop across the catalytic membrane during use may be less than 1000 kPa. The pressure drop across the catalytic membrane during use may be less than 750 kPa. The pressure drop across the catalytic membrane during use may be less than 500 kPa. The pressure drop across the catalytic membrane during use may be less than 250 kPa. The pressure drop across the catalytic membrane during use may be less than 100 kPa.

In a second aspect there is provided a catalytic module comprising at least one catalytic membrane according to the first aspect spanning an aperture defined in a support.

The support may comprise at least one location features. The at least one location features may be configured to allow the aperture of a first catalytic module and a second catalytic module to be aligned to form a single channel. The support may comprise at least one first location feature provided on a first side of the catalytic module and at least one second location feature provided on an opposed second side of the catalytic module. The at least one first location feature may be configured to be matedly connected to the at least one second location feature to thereby connect a first catalytic module to a second catalytic module such that the aperture of the first catalytic module is aligned with the aperture of the second catalytic module.

The catalytic module may comprise at least two catalytic membranes according to the first aspect. The catalytic module may comprise at least three catalytic membranes according to the first aspect.

The catalytic module may comprise from 1 to 100 catalytic membranes. The catalytic module may comprise from 1 to 75 catalytic membranes. The catalytic module may comprise from 1 to 50 catalytic membranes. The catalytic module may comprise from 1 to 40 catalytic membranes. The catalytic module may comprise from 1 to 30 catalytic membranes. The catalytic module may comprise from 1 to 20 catalytic membranes. The catalytic module may comprise from 1 to 10 catalytic membranes. The catalytic module may comprise from 2 to 100 catalytic membranes. The catalytic module may comprise from 3 to 100 catalytic membranes. The catalytic module may comprise from 5 to 100 catalytic membranes. The catalytic module may comprise from 10 to 100 catalytic membranes. The catalytic module may comprise from 20 to 100 catalytic membranes.

The number of catalytic membranes of the catalytic module may be configured to maximise the available catalyst for reactants flowing through the catalytic module whilst maintaining an acceptable pressure drop across the catalytic module.

Features of the catalytic membrane of the first aspect are features of the catalytic membrane of the second aspect.

According to a third aspect there is provided a modular reactor comprising at least one input module, at least one output module and at least one catalytic module according to the second aspect, wherein the modular reactor is configured such that fluid may flow from the at least one input module to the at least one output module through the catalytic membranes of the at least one catalytic module.

The modules of the modular reactor may comprise at least one location features. The at least one location features may be configured to allow the aperture of a module and a second module to be aligned to form a channel. Each module may comprise at least one first location feature provided on a first side of the module and at least one second location feature provided on an opposed second side of the module. The at least one first location feature of a first module may be configured to be matedly connected to the at least one second location feature of a second module to thereby connect a first module to a second module such that the aperture of the first module is aligned with the aperture of the second module.

The modular reactor may comprise at least a first catalytic module and a second catalytic module. The first catalytic module may comprise at least one first catalytic membrane. The second catalytic module may comprise at least one second catalytic membrane. The at least one first catalytic membrane may be the same as the at least one second catalytic membrane. The at least one first catalytic membrane may be different to the at least one second catalytic membrane. The catalyst particles of the at least one first catalytic membrane may be the same as the catalyst particles of the at least one second catalytic membrane. The catalyst particles of the at least one first catalytic membrane may be different to the catalyst particles of the at least one second catalytic membrane.

The modular reactor may comprise at least one secondary input module. The at least one secondary input module may be configured to allow fluid to be input into the reactor. During use a fluid stream may flow from the at least one input to the at least one output. During use, additional reactants and/or solvent may be input into the fluid stream via the at least one secondary input module.

The modular reactor may comprise at least one heat exchange module, the at least one heat exchange module comprising a support defining an aperture and an open structure spanning the aperture. The open structure may be an open lattice structure.

The heat exchange module may be configured to allow the exchange of heat between the heat exchange module and a fluid flowing through the modular reactor during use.

The heat exchange module may be configured to induce mixing of fluids flowing through the heat exchange module. The heat exchange module may comprise mixing elements that extend into the flow path of the modular reactor. The mixing elements may induce turbulence in the fluid flow. The mixing elements may be shaped to induce turbulence in the fluid flow.

The heat exchange module may comprise a heat conductive material. For example, the heat conductive material may be metallic. The conductive material may be copper, aluminum, steel, stainless steel or similar.

The heat exchange module may be in thermal communication with an external heat exchanger. The external heat exchanger may comprise a flow of coolant fluid. Accordingly, the modular reactor may comprise one or more coolant fluid circuits.

The heat exchange module may be provided downstream from at least one catalytic module. Accordingly, heat generated by a chemical reaction catalysed by the catalyst particles in the catalytic membrane of the catalytic module may be removed from the fluid flowing through the modular reactor by the heat exchange module.

The heat exchange module may be provided upstream from at least one catalytic module. Accordingly, heat may be provided from the heat exchange module to the fluid flowing through the modular reactor to promote a chemical reaction catalysed by the catalyst particles in the catalytic module.

The modular reactor may comprise a spacer module. The spacer module may comprise a support defining an aperture. The spacer module may be positioned between a first catalytic module and a second catalytic module.

The modular reactor may comprise a measurement module. The measurement module may comprise one or more sensors extending into an aperture defined by a support. Accordingly, during use the one or more sensors may directly contact fluid flowing through the aperture to thereby sense or measure a parameter of the fluid flowing through the aperture.

The modular reactor may comprise a mixing module. The mixing module may comprise a support defining an aperture and at least one mixing element extending into the aperture. Accordingly, the at least one mixing element may induce mixing in fluid flowing through the aperture of the mixing module.

The modules of the modular reactor may be multifunctional. For example, a spacer module may comprise one or more sensors extending into an aperture defined by the support and may therefore combine the functionality of a spacer module and a measurement module.

In a fourth aspect there is provided a reactor for continuous flow reactions, the reactor comprising a reaction chamber, an inlet, an outlet and a catalytic membrane according to the first aspect that spans the reaction chamber, wherein the inlet and outlet are in fluid communication with the reaction chamber such that during use fluid flows from the inlet to the outlet via the reaction chamber, wherein substantially all fluid flowing from the inlet to the outlet passes through the catalytic membrane.

In some embodiments a seal may be provided at the interface between the catalytic membrane and the interior surface of the reaction chamber.

The reactor may further comprise a plurality of catalytic membranes according to the first aspect provided in series along the length of at least a portion of the reaction chamber. The reactor may comprise at least two catalytic membranes provided in series along the length of at least a portion of the reaction chamber. The reactor may comprise at least three catalytic membranes provided in series along the length of at least a portion of the reaction chamber. The reactor may comprise at least four catalytic membranes provided in series along the length of at least a portion of the reaction chamber. The reactor may comprise at least five catalytic membranes provided in series along the length of at least a portion of the reaction chamber.

The reactor may comprise from 1 to 100 catalytic membranes. The reactor may comprise from 1 to 75 catalytic membranes. The reactor may comprise from 1 to 50 catalytic membranes. The reactor may comprise from 1 to 40 catalytic membranes. The reactor may comprise from 1 to 30 catalytic membranes. The reactor may comprise from 1 to 20 catalytic membranes. The reactor may comprise from 1 to 10 catalytic membranes. The reactor may comprise from 2 to 100 catalytic membranes. The reactor may comprise from 3 to 100 catalytic membranes. The reactor may comprise from 5 to 100 catalytic membranes. The reactor may comprise from 10 to 100 catalytic membranes. The reactor may comprise from 20 to 100 catalytic membranes.

The number of catalytic membranes of the reactor may be configured to maximise the available catalyst for reactants flowing through the catalytic module whilst maintaining an acceptable pressure drop across the reactor.

The reactor may further comprise a spacer located between at least two adjacent catalytic membranes within the plurality of catalytic membranes. The spacer may be provided in contact with at least one of two adjacent catalytic membranes within the plurality of catalytic membranes. The spacer may be provided in contact with both of two adjacent catalytic membranes.

The spacer may be configured to separate adjacent catalytic membranes within the plurality of catalytic membranes without substantially impeding the flow of fluid between the adjacent catalytic membranes during use. The spacer may be configured to separate adjacent catalytic membranes within the plurality of catalytic membranes whilst optimising the flow of fluid between the adjacent catalytic membranes during use.

The plurality of catalytic membranes may comprise at least two groups of catalytic membranes. The at least two groups of catalytic membranes may comprise at least two catalytic membranes. The spacer may be configured to separate at least two adjacent groups of the at least two groups of catalytic membranes. The spacer may be configured to separate at least two adjacent groups of the at least two groups of catalytic membranes whilst optimising the flow of fluid between the adjacent catalytic membranes during use.

Accordingly, the spacer may comprise an aperture to all allow to flow between the adjacent catalytic membranes of the plurality of catalytic membranes during use. The spacer may be annular. The spacer may form a ring. The aperture of the spacer may be provided centrally. The reaction chamber may comprise a central axis and the aperture of the spacer may be centred onto the central axis.

The spacer may comprise a plurality of apertures. The spacer may provide structural support to one or more catalytic membranes. The spacer may provide structural support to the catalytic membrane that is provided upstream of the spacer. The spacer may be configured to act as a support layer to a catalytic membrane. Accordingly, a catalytic membrane that is supported by the spacer may not require an additional support layer to achieve the desired structural strength of the catalytic membrane to withstand the pressure drop between the two surfaces of the catalytic membrane without deformation or damage.

For the avoidance of doubt, the term “upstream” refers to the side of an article closer to the inlet of the reaction chamber than the outlet of the reaction chamber. The term “downstream” refers to the side of an article that is closer to the outlet of the reaction chamber than the inlet of the reaction chamber. For example, the upstream side of a catalytic membrane is the side that is directly impacted by fluid flowing through the reaction chamber from the inlet to the outlet.

The reactor chamber may comprise a heat exchanger. The heat exchanger may be configured to allow the exchange of heat between the heat exchanger and a fluid flowing through the reactor during use. The heat exchanger may comprise an open structure. The open structure may be an open lattice structure.

The heat exchanger may be configured to induce mixing of fluids flowing through the heat exchanger. The heat exchanger may comprise mixing elements that extend into the flow path of the reactor. The mixing elements may induce turbulence in the fluid flow. The mixing elements may be shaped to induce turbulence in the fluid flow.

The heat exchanger may comprise a heat conductive material. For example, the heat conductive material may be metallic. The conductive material may be copper, aluminum, steel, stainless steel or similar.

The heat exchanger may be in thermal communication with an external heat exchanger. The external heat exchanger may comprise a flow of coolant fluid. Accordingly, the reactor may comprise one or more coolant fluid circuits.

The heat exchanger may be provided downstream from at least one catalytic membrane. Accordingly, heat generated by a chemical reaction catalysed by the catalyst particles in the catalytic membrane may be removed from the fluid flowing through the reactor by the heat exchanger.

The heat exchanger may be provided upstream from at least one catalytic membrane. Accordingly, heat may be provided from the heat exchanger to the fluid flowing through the reactor to promote a chemical reaction catalysed by the catalyst particles in the catalytic membrane.

The reactor chamber may comprise mixing elements. The mixing elements may induce mixing of fluid flowing through the reactor chamber.

The reactor chamber may be configured such that fluid flowing through the reactor adopts a plug flow profile. Accordingly, fluid flowing through the reactor chamber may flow at the same velocity across the full width or substantially the full width of the reactor chamber.

The reactor chamber may comprise an instrument port. The instrument port may be located such that instruments may be positioned into the fluid flow. The instrument port may be located in the reactor chamber such that instruments may be positioned through the instrument port into the fluid flow without impacting the flow profile of the fluid flowing through the reactor chamber. The instrument port may allow sensors to be positioned within the fluid flow. Non-limiting examples of sensors may include temperature sensors, pressure sensors, or pH sensors. The instrument port may allow instruments such as spectroscopic probes to be positioned within the fluid flow.

The reactor chamber may comprise one or more auxiliary inlets. The one or more auxiliary inlets may allow one or more additional reactants to be introduced into the fluid flow. The one or more additional reactants may be a component of the original fluid that flowed into the reactor chamber via the inlet. Accordingly, the one or more additional reactant may correspond to more of one or more of the original reactants. The one or more additional reactants may be a new reactant and may be introduced to initiate a subsequent step of a reaction process. Accordingly, the reactor chamber may be configured to allow multi-step process to be carried out within a single reactor chamber. The one or more auxiliary inlets may allow additional solvent to be introduced into the fluid flow.

The reactor chamber may comprise one or more auxiliary outlets. The one or more auxiliary outlets may allow samples to be withdrawn from the fluid flowing through the reactor. The withdrawn sample may allow the content of the fluid at that point of the reactor to be determined.

During use, fluid typically flows through the reactor from the inlet to the outlet through the reaction chamber and flows through the or each catalytic membrane. Typically, there is no pathway for fluid to flow around or to bypass the or each catalytic membrane. Accordingly, at least 70% of fluid flowing through the reactor flows through the or each catalytic membrane. At least 80% of fluid flowing through the reactor flows through the or each catalytic membrane. At least 90% of fluid flowing through the reactor flows through the or each catalytic membrane. At least 95% of fluid flowing through the reactor flows through the or each catalytic membrane. At least 99% of fluid flowing through the reactor flows through the or each catalytic membrane.

The pressure drop across the catalytic membrane during use may be from 0.069 kPa (0.01 psi) per membrane to 2068 kPa (300 psi) per membrane. The pressure drop across the catalytic membrane during use may be from 0.069 kPa per membrane to 2000 kPa per membrane. The pressure drop across the catalytic membrane during use may be from 0.069 kPa per membrane to 1750 kPa per membrane. The pressure drop across the catalytic membrane during use may be from 0.069 kPa per membrane to 1500 kPa per membrane. The pressure drop across the catalytic membrane during use may be from 0.069 kPa per membrane to 1250 kPa per membrane. The pressure drop across the catalytic membrane during use may be from 0.069 kPa per membrane to 1000 kPa per membrane. The pressure drop across the catalytic membrane during use may be from 0.069 kPa per membrane to 750 kPa per membrane. The pressure drop across the catalytic membrane during use may be from 0.069 kPa per membrane to 500 kPa per membrane. The pressure drop across the catalytic membrane during use may be from 0.069 kPa per membrane to 250 kPa per membrane. The pressure drop across the catalytic membrane during use may be from 0.1 kPa per membrane to 2068 kPa per membrane. The pressure drop across the catalytic membrane during use may be from 0.5 kPa per membrane to 2068 kPa per membrane. The pressure drop across the catalytic membrane during use may be from 1 kPa per membrane to 2068 kPa per membrane. The pressure drop across the catalytic membrane during use may be from 5 kPa per membrane to 2068 kPa per membrane. The pressure drop across the catalytic membrane during use may be from 10 kPa per membrane to 2068 kPa per membrane. The pressure drop across the catalytic membrane during use may be from 50 kPa per membrane to 2068 kPa per membrane. The pressure drop across the catalytic membrane during use may be from 100 kPa per membrane to 2068 kPa per membrane. The pressure drop across the catalytic membrane during use may be from 150 kPa per membrane 10 to 2068 kPa per membrane. The pressure drop across the catalytic membrane during use may be from 200 kPa per membrane to 2068 kPa per membrane. The pressure drop across the catalytic membrane during use may be from 500 kPa per membrane to 2068 kPa per membrane. The pressure drop across the catalytic membrane during use may be from 1000 kPa per membrane to 2068 kPa per membrane. The pressure drop across the catalytic membrane during use may be from 1500 kPa per membrane to 2068 kPa per membrane.

The pressure drop across the catalytic membrane during use may be less than 2000 kPa per membrane. The pressure drop across the catalytic membrane during use may be less than 1500 kPa per membrane. The pressure drop across the catalytic membrane during use may be less than 1000 kPa per membrane. The pressure drop across the catalytic membrane during use may be less than 750 kPa per membrane. The pressure drop across the catalytic membrane during use may be less than 500 kPa per membrane. The pressure drop across the catalytic membrane during use may be less than 250 kPa per membrane. The pressure drop across the catalytic membrane during use may be less than 100 kPa per membrane.

During use, fluid comprising reactants may be continuously flowed into the inlet of the reactor such that the reaction products continuously flow out of the outlet of the reactor. The reactor may be configured to provide a constant flow rate per unit area of catalytic membrane. The provision of a constant flow rate per unit area (flux) of catalytic membrane may allow the reactor to be readily scaled as desired for a given chemical reaction or application by simply scaling the catalytic membrane diameter and flow rate accordingly to maintain the flux.

Features of the catalytic membrane of the first aspect are features of the catalytic membrane of the catalytic module of the second aspect and the catalytic membrane of the fourth aspect.

It is to be understood that the features of the modules of the third aspect are features of the reactor of the fourth aspect where appropriate. For example, features of the heat exchange module of the third aspect are features of the heat exchanger of the reactor of the fourth aspect.

### BRIEF DESCRIPTION OF THE FIGURES

Embodiments of the present invention will now be described, by way of non-limiting example, with reference to the accompanying drawings.

FIG. 1: A side schematic view of a catalytic membrane according to embodiments;

FIG. 2: A) A side schematic view of a series of catalytic membranes according to embodiments and B) a side schematic view of a catalytic membrane of the series of catalytic membrane;

FIG. 3: A) A side schematic view of a reactor comprising a plurality of catalytic membranes according to embodiments and B) a side schematic view of a catalytic membrane of the plurality of catalytic membranes;

FIG. 4: A side view of a reactor module according to an embodiment in exploded and assembled form;

FIG. 5: A side cross-section view of a flow-by type cartridge;

FIG. 6: A side schematic cross-sectional view of a reactor according to an embodiment;

FIG. 7: A flow diagram of a reactor according to an embodiment;

FIG. 8: A side cross-sectional view of a modular reactor according to an embodiment;

FIG. 9: A) a cross-sectional view of a catalytic layer according to an embodiment, B) a perspective view of a catalytic layer, and C) a cross-sectional view of a catalytic layer according to an embodiment;

FIG. 10: A plot of 1/(weight hourly space velocity) vs reaction yield % for reactor cartridge RC-2-1. RC-2-2;

FIG. 11: A plot of 1/whsv vs reaction yield % for RC-4-1, RC-4-2;

FIG. 12: A plot of 1/whsv vs reaction yield % for RC-5-1, RC-5-2, RC-5-3;

FIG. 13: A plot of time on stream vs reaction yield % for RC-6-1, RC-6-2, RC-5-2 at liquid inlet flow rate 1 g/min;

FIG. 14: A plot of time on stream vs reaction yield % for RC-6-1, RC-6-2, RC-5-2 at liquid inlet flow rate 2.5 g/min;

FIG. 15: A plot of time on stream vs reaction yield % for RC-6-1, RC-6-2, RC-5-2 at liquid flow rate 5 g/min;

FIG. 16: A plot of 1/whsv vs reaction yield % for RC-8-1, RC-8-2, RC-5-3;

FIG. 17: A plot of 1/whsv vs reaction yield % for RC-9-1, RC-9-2;

FIG. 18: Perspective schematic view of two examples of measurement layers or modules comprising thermocouples according to embodiments;

FIG. 19: A plot to temperature over time for positions within a reactor as measured by thermocouples at the outlet compared to the initial water temperature as input into the inlet (“hot feed”) and the coolant water used in a heat exchange module; and

FIG. 20: A plot of 1/whsv vs reaction yield % for RC-11-1, RC-11-2.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

### Test Methods

### Thickness of the Catalytic Membranes

The thickness of the catalytic membranes was measured using a caliper as follows: The thickness of two glass-slides and the thickness of the catalytic membrane placed between the two glass-slides were measured using the caliper. The thickness of the catalytic membrane was estimated by subtracting the second value from the first one.

### Mercury Intrusion Measurements

Measurements were carried out on a Micromeritics AutoPore V mercury porosimeter (Micromeritics, Norcross, Ga., USA), using Micromeritics MicroActive software version 2.0. Quadruple distilled virgin mercury—99.9995% purity (Bethlehem Apparatus, Bethlehem, Pa.) was used as received for tests. Pieces of the composite samples were cut into small pieces. The strips were first placed in a vacuum oven and outgassed at approximately 80° C. overnight. Enough of these strips were weighed on an analytical balance to provide a total mass of approximately ˜0.12 to ˜0.25 g. After noting the mass, the sample pieces were placed in the penetrometer (5 cc or 3 cc solid type penetrometer).

The test parameters were as follows: (1) the penetrometer was placed into the low pressure port on the AutoPore and evacuated to 50 mm Hg (6.7 kPa), followed by 5 min unrestricted evacuation; (2) the penetrometer was then filled with mercury at 0.5 psia (about 3.5 kPa) and equilibrated for 10 seconds; pressure was subsequently applied to the capillary using nitrogen in steps up to 30 psi (˜0.21 MPa), equilibrating for 10 seconds at each step prior to determining the intrusion volume via the standard capacitance measurement with the penetrometer capillary; (3) the penetrometer was removed from the low pressure port after returning to atmospheric pressure and then weighed to determine the amount of mercury added; (4) the penetrometer was subsequently placed into the high pressure port on the AutoPore and the pressure was again increased in a series of steps up to approximately 60,000 psi (˜413.7 MPa) allowing 10 sec at each step to equilibrate prior to intrusion volume measurements.

The intrusion volume V at any pressure is determined through a capacitance measurement using the pre-calibrated capillary (i.e., a cylindrical capacitor where the outer contact is the metallized coating on the external surface of the glass capillary, the inner contact is the liquid mercury, and the dielectric is the glass capillary). The total intrusion volume divided by the sample mass gives the specific pore (intrusion) volume (in mL/g).

The specific pore volume due to pores having sizes between 0.1 μm and 90 μm was calculated as from the difference the cumulative intrusion volumes for pores having diameter 0.1 μm minus the cumulative intrusion volumes for pores having diameter 90 μm. The cumulative specific intrusion volume and the corresponding pressures are provided as tabular output by the instrument.

The intrusion pressure that corresponds to each of these sizes was calculated using the Washburn equation:

$${P}_{i} = \frac{{k}_{washburn} γ ( - 4 cos ϑ )}{{D}_{i}}$$

Where Pᵢ is the equilibrium pressure that corresponds to pores with diameter Dᵢ, k_{washburn} is the Washburn constant equal to 0.145038, γ is the surface tension of mercury (0.485 N/m), and e is the contact angle of mercury and sample (used value of 130°).

### Bulk Density

The bulk density of the sample is defined as the ratio of the mass of the sample divided by its total volume (volume of solid, interparticle and intraparticle volume). The bulk density was estimated as follows: A 14 mm diameter disk was cut from each sample. The weight and thickness of the disk were then measured. The volume of the disk was then calculated by using the formula that provides the volume of a cylinder:

$${V}_{sample} = \frac{π {D}^{2}}{4} h$$

Where D is the diameter of the disk (14 mm) and h is the measured thickness. Sample mass was determined by weighing on an analytical balance of +/−0.01 mg sensitivity.

### BET Specific Surface Area

The BET specific surface area was estimated from N₂ physisorption curves measured at ˜77K. Such isotherms can be measured using commercially available instruments (i.e. Autosorb-iQ or NOVA by Quantachrome), and using procedures known to those skilled in the art. Prior to each measurement the adsorbents were outgassed at 180° C. in vacuum. The sample was then transferred to the measuring port, and the N₂ adsorbed (q) is measured as a function of N₂ partial pressure (P) at 77K. The BET surface area was calculated from the adsorption isotherm branch using procedures described in the “Physisorption of gases, with special reference to the evaluation of surface area and pore size distribution” (IUPAC Technical Report)” by M. Thommes et al. Pure Appl. Chem. 2015; 87(9-10) 1051-1069 as implemented in the ASiQWin software by Quantachrome.

### Airflow Resistivity

The general procedure and testing apparatus configuration for measuring airflow resistivity was taken from ISO 9053-1:2018. Due to a lack of rigidity for some samples, all samples were restrained to ensure accurate evaluation of their specific airflow resistance. A stainless-steel ring with an adhesive backing that has an outer diameter less than 4.2 cm and an inner diameter greater than 3.6 cm was prepared. This ring was then placed upon the material and lightly pressed to ensure effective adhesion. A 4.2 cm diameter circle of material was the cut from the bulk via fixed blade, punch, or laser. The thickness of the sample was then estimated using a Mitutoyo Litematic VL-50S-B. Measurements were taken at each edge of the sample and the center to provide a total of 5 distinct measurements. These thickness measurements were then averaged to provide the estimated sample thickness. Samples were the loaded into a two part sample holder that was then inserted into the flow chamber. The sample holder allowed for samples with an outer diameter of up to 4.2 cm and a thickness up to 2 mm. The effective flow area provided by the sample holder had a diameter of 3.46 cm. Once the sample holder was inserted, it was locked into place such that two distinct O-rings sealed the flow chamber to prevent any bypass. Before measuring any unknown materials, a known standard woven mesh was measured to verify system accuracy. The limits of the system to measure pressure drop were dependent upon which differential pressure transducer was installed and ranged from a minimum of 0.2 Pa to a maximum of 2500 Pa. For material evaluation, linear velocities of 0.0125 cm/s to 0.75 cm/s were used to ensure the pressure drop was in this range. For each linear velocity, at least five distinct pressure drop measurements were taken and averaged to estimate the pressure drop at that velocity. Only data above the minimum pressure level of the installed transducer was considered valid. In general, only the data from the lowest four flow rates that provided sufficient pressure drop was used to ensure laminar flow. The specific airflow resistance was then calculated by dividing each average pressure drop by each linear velocity. The airflow resistivity of the sample was then calculated by dividing the specific airflow resistance by the estimated sample thickness measured previously.

### Mechanical Properties

To evaluate the mechanical properties of the catalytic membrane, a membrane sample was cut in the longitudinal and transverse directions using ASTM D412—Dogbone Die Type F (D412F). Tensile properties were measured using an INSTRON® 5565 (Illinois Tool Works Inc., Norwood, MA) tensile test machine equipped with flat-faced grips and a 100 N load cell. The grips distance was set to 8.26 cm and the strain rate was 0.847 cm/s. After placing the sample in the grips, the sample was retracted 1.27 cm to obtain a baseline followed by a tensile test at aforementioned strain rate.

The cross-sectional area of the unstrained sample was calculated by multiplying the sample thickness with gauge width.

The strain at any in point in time of the test is defined as:

$$strain = \frac{sample length under stress - initial sample length}{initial sample length}$$

The tensile strength of the sample was calculated by dividing the maximum load (i.e. peak force) of each stress-strain curve by cross-sectional area of the unstrained specimen.

The Young's modulus of each sample was calculated as follows. The slope of the linear section of the load-strain curve was calculated by doing linear regression. The slope was then divided by the cross-sectional area of the unstrained sample to provide the Young's modulus.

The yield stress was calculated as the stress that would result to a 0.2% plastic deformation.

### Particle Size Distribution Measurements

The mean volume diameter of the catalyst particles was measured using a Microtrac Sync Size and Shape Particle Analyzer. This instrument performs size distribution measurements using laser light diffraction/scattering. About 0.1 gr of powder was mixed with ˜5 ml of isopropanol using a 20 ml scintillation vial. The vial was then shaken until the powder is properly suspended in the isopropanol. The dispersion was then loaded into the instrument's hopper for analysis. The amount was adjusted until the light transmission is in the 88-90% range before beginning data collection.

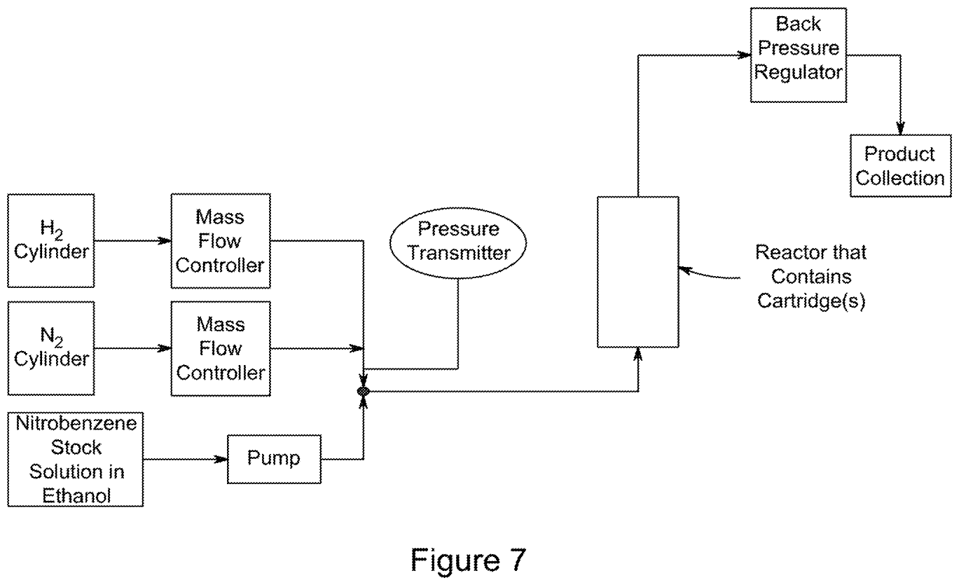

The pressure drop is calculated by subtracting the setting of the back pressure regulator from the pressure reading of the inlet pressure transducer (see FIG. 7, for example).

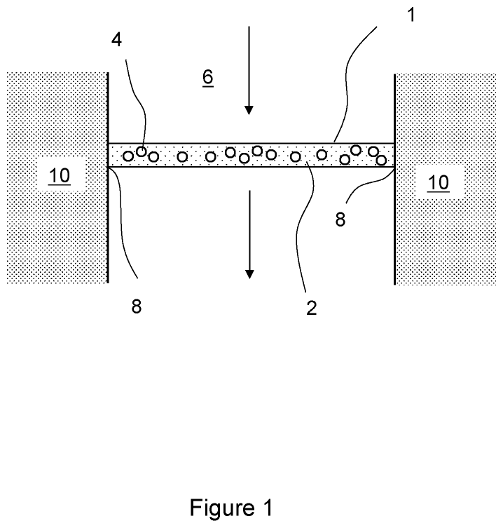

With reference to FIG. 1, a catalytic membrane 1 comprises an expanded polytetrafluoroethylene (ePTFE) membrane 2 (acting as a fluoropolymer film) and catalytic particles 4 enmeshed within the fibrils of the ePTFE membrane 2.

The catalytic particles 4 comprise alumina (Al₂O₃) and metallic palladium (Pd).

The catalytic membrane 1 spans the channel 6 of a reactor chamber and a seal 8 is formed around the perimeter of the catalytic membrane 1 where the catalytic membrane 1 connects to the wall 10 of the reactor chamber. Accordingly, during use, fluid flowing through the reactor chamber 8 flows through the catalytic membrane 1 and contacts the palladium of the catalytic particles.

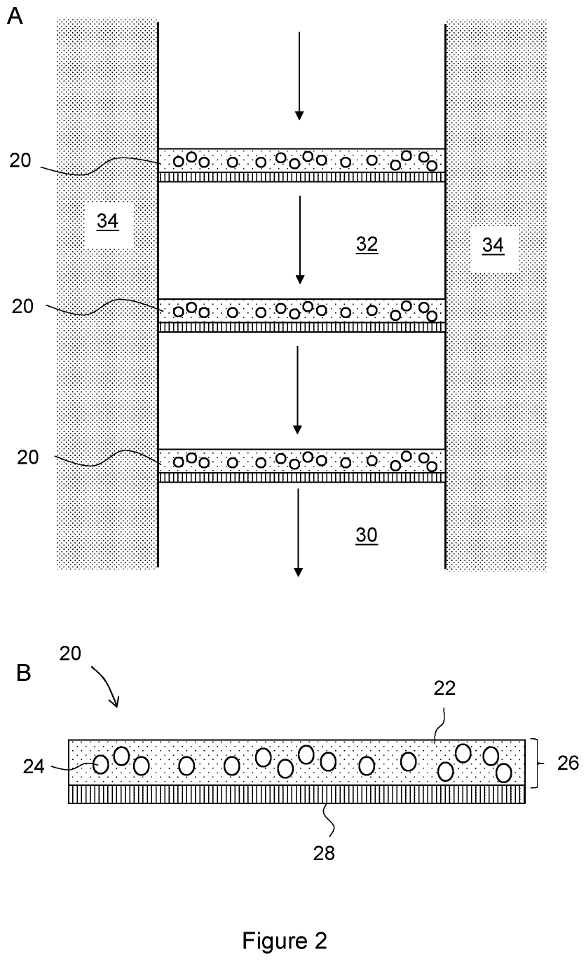

With reference to FIG. 2, a catalytic membrane 20 comprises an ePTFE membrane 22, catalytic particles 24 enmeshed within the fibrils of the ePTFE membrane 22 to form a porous catalytic fluoropolymer film 26 and a stainless steel grid 28 (acting as a support layer).

The catalytic particles 24 comprise carbon and particles of metallic vanadium (V) and platinum (Pt).

Three of the catalytic membranes 20 are arranged in a channel 30 of a reactor chamber 32 in series, each catalytic membrane 20 spanning the channel 30 and a seal is formed around the perimeter of the catalytic membrane 20 where the catalytic membrane connects to the wall 34 of the reactor chamber 32. The stainless steel grid 28 of each catalytic membrane 20 is provided on the downstream side of the catalytic membrane 20 such that it may brace the porous catalytic fluoropolymer film 26 against the pressure applied to the catalytic membrane 20.

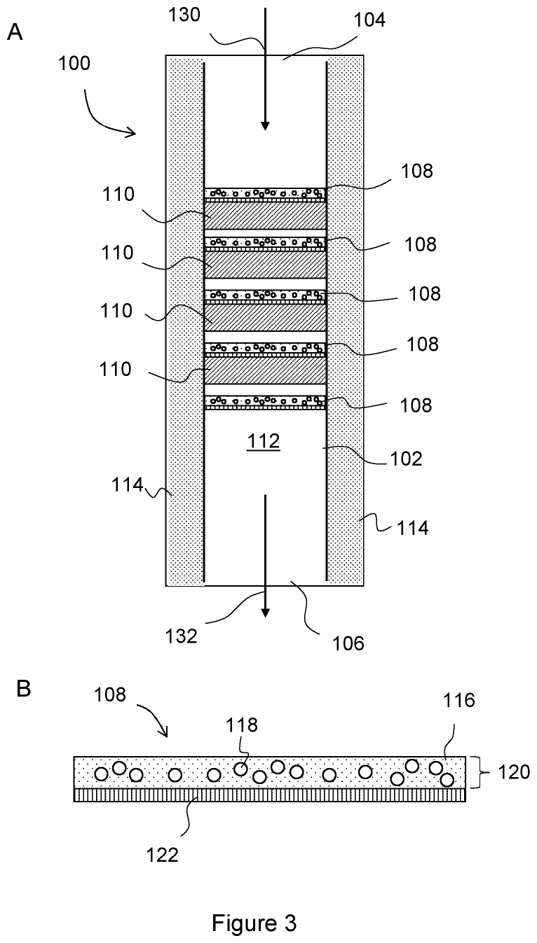

With reference to FIG. 3 a reactor 100 comprises a reactor chamber 102, an inlet 104 and an outlet 106. The reactor chamber 102 comprises five catalytic membranes 108 arranged in series along the length of a catalytic portion of reactor chamber 102 (acting as at least a portion of the reaction chamber) and a tubular spacer 110 (acting as a spacer) provided between adjacent catalytic membranes 108. The reactor chamber 102 comprises a channel 112 defined by reactor walls 114, the channel 112 being in fluid connection with the inlet 104 and the outlet 106 such that during use fluid may flow from the inlet 104 to the outlet 106 via the channel 112 of the reactor chamber 102. Each catalytic membrane 108 comprises an ePTFE membrane 116, catalytic particles 118 enmeshed within the fibrils of the ePTFE membrane 116 to form a porous catalytic fluoropolymer film 120 and a stainless steel grid 122 (acting as a support layer). The catalytic particles 118 comprise alumina (Al₂O₃) and particles of palladium (Pd).

Each catalytic membrane 108 spans the channel 112 of a reactor chamber 102 and a seal is formed around the perimeter of the catalytic membrane 108 where the catalytic membrane 108 connects to the reactor walls 114 of the reactor chamber 102.

During use, fluid comprising reactants 130 flows from the inlet 104 to the reactor chamber 102 and flows through each catalytic membrane 108 such that the reactants in the fluid contact the palladium in the catalytic membranes 108. The palladium catalyses the reaction of the reactants to form products. The fluid comprising the products 132 flows from the reactor chamber 102 to the outlet 106.

Accordingly, provision of catalytic membranes ensures that the reactants contact the catalyst for the reaction with high efficiency to thereby increase the efficiency of the reactor when compared to standard methods such as packed bed systems, for example.

With reference to the schematic flow diagram of an example reactor of FIG. 7 hydrogen and nitrogen gas is fed to mass flow controllers, and reactant stock (in this example nitrobenzene stock solution in ethanol) is fed to a pump. Hydrogen, nitrogen and reactant stock is fed from the mass flow controllers and pump to a reactor comprising reactor cartridges that comprise catalytic membranes according to embodiments. Fluid comprising reaction products exits the reactor to a back pressure regulator and from there to product collection.

### Example Modular Reactor

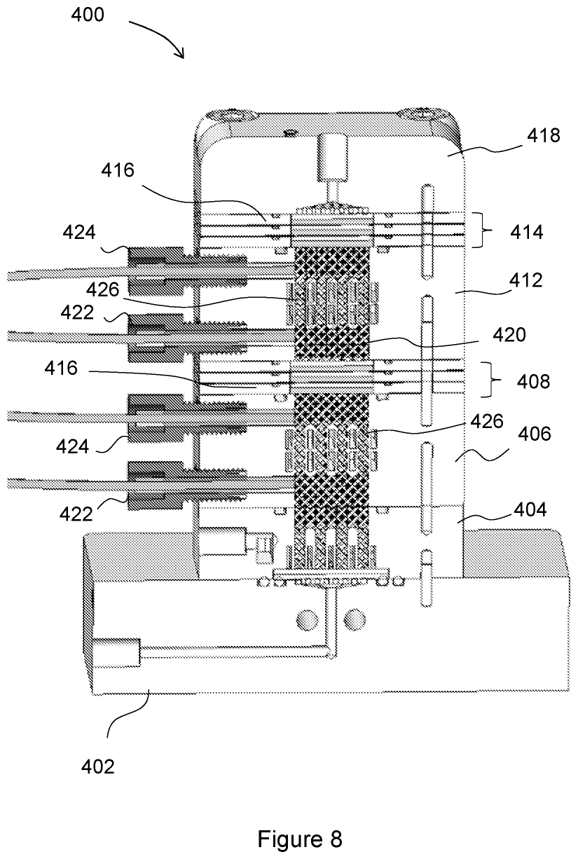

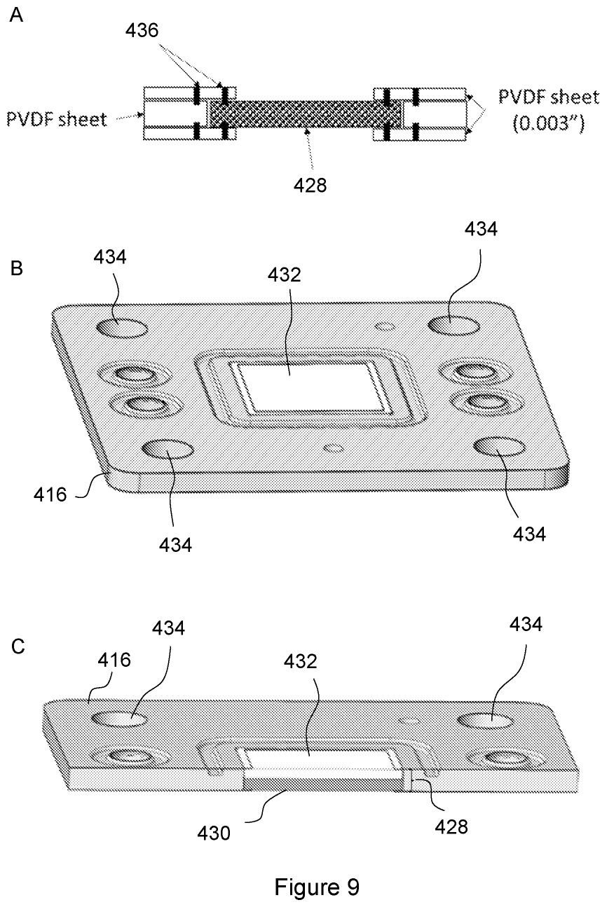

With reference to FIGS. 8 and 9, an example modular reactor 400 comprises a first input module 402, a second input module 404, a first heat exchange module 406, a first catalytic module 408, a second heat exchange module 412, a second catalytic module 414 and an output module 418. A common channel flows from the first input module 402 to the output module 418. During use fluid comprising the reactants flows from the first and second input modules 402, 404 to the output module 418 via the first and second heat exchange modules 406, 412 and first and second catalytic modules 408, 414. The first and second heat exchange modules 406, 412 comprise a coolant input 422 and a coolant output 424 and a metal lattice 426 that extends into the common channel. The first and second catalytic modules 408, 414 comprise three catalytic layers 416. Each catalytic layer 416 comprises a catalytic membrane 428, each catalytic membrane 428 comprising a catalytic ePTFE film 430, a support layer 432 and location features 434. The catalytic membrane 428 is secured in place with heat welds 436.

### Example Catalytic Membranes

Catalytic membranes were made following the general method below:

The porous fibrillated polymer membrane may be formed by blending fibrillating polymer particles with the supported catalyst particles in a manner such as is generally taught in United States Publication No. 2005/0057888 to Mitchell, et al., United States Publication No. 2010/0119699 to Zhong, et al., U.S. Pat. No. 5,849,235 to Sassa, et al., U.S. Pat. No. 6,218,000 to Rudolf, et al., or U.S. Pat. No. 4,985,296 to Mortimer, Jr., followed by uniaxial or biaxial expansion. As used herein, the term “fibrillating” refers to the ability of the fibrillating polymer to form a node and fibril microstructure. The mixing may be accomplished, for example, by wet or dry mixing, by dispersion, or by coagulation. Time and temperatures at which the mixing occurs varies with particle size, material used, amount of particles being co-mixed, etc. and are easily identified by those of skill in the art. The uniaxial or biaxial expansion may be in a continuous or batch processes known in those of skill in the art and as generally described in U.S. Pat. No. 3,953,566 to Gore and U.S. Pat. No. 4,478,665 to Hubis.

TABLE 1
Catalytic particles used in the catalytic membranes.

| | Catalyst ID | | | |
|---|---|---|---|---|
| | C1 | C2 | C3 | C4 |
| | 5 wt % Pd/Al₂O₃ | 5 wt % Pd/C | 5 wt % Pd/C | 1 wt % Pt/V/C |
| Supplier | Johnson | Johnson | Johnson | Evonik |
| | Matthey | Matthey | Matthey | |
| Type | A302011-5 | 5R452 | 5R487 | P8072 |

The physical features of examples of catalytic membranes are provided in Tables 2 & 3 below:

TABLE 2

| | Catalytic | Loading | Thickness | | | Bulk | | |
|---|---|---|---|---|---|---|---|---|
| Example | Particle | wt % | μm | TSPV | SPV | Density | BET | AFR |
| 1 | C1 | 85 | 206 | 0.604 | 0.241 | 1.12 | 135.7 | 4.02e08 |
| 2 | C1 | 85 | 216 | 0.702 | 0.34 | 1.014 | 124.1 | 1.38e08 |
| 3 | C2 | 25 | 380 | 1.602 | 1.433 | 0.626 | — | — |
| 4 | C2 | 25 | — | — | — | — | — | — |
| 5, 6, 8 & | C3 | 75 | 1170 | 1.41 | 1.17 | 0.54 | 653 | 9.61e07 |
| 11 | | | | | | | | |
| 7 | C4 | 25 | 322 | | | 0.46 | | 2.7e08 |
| 9 | C2 | 75 | 1500 | 1.426 | 1.28 | 0.47 | 713.95 | 4.62e07 |

Example catalytic membranes where:
TSPV-Total specific pore volume, cc/gr;
SPV-Specific pore volume 0.1-90 μm, cc/gr;
Bulk density g/cm³;
BET-BET specific surface area, m²/g; and
AFR-Air flow resistivity, Pa s/m²

TABLE 3

| | Tensile | | Yield Stress, | | Young's | |
|---|---|---|---|---|---|---|
| | Strength, MPa | | MPa | | Modulus, MPa | |
| Example | MD | TD | MD | TD | MD | TD |
| 1 | 1.5 | 0.26 | 0.9 | 0.16 | 7.84 | 3.9 |
| 5, 6, 8 & | — | 0.14 | — | 0.05 | — | 1.96 |
| 11 | | | | | | |
| 9 | 0.13 | 0.06 | 0.09 | 0.03 | 1.55 | 0.87 |

Physical properties of example catalytic membranes,
MD is machine direction,
TD is transverse direction.

The performance of the catalytic membranes of the examples were compared. Example Comparison between reactors: Weight Hourly Space Velocity (WHSV) is calculated by multiplying the mass feed flow rate of the reactant with the mass of metal catalyst in the reactor. 1/WHSV has units of time (hr) and can be considered as an indication of residence time with respect to the amount catalyst in the reactor. The higher the yield at a set 1/WHSV or same yield at lower 1/WHSV indicate better performance. There are no assumption in these calculations.

### Reactors Comprising Catalytic Membranes of the Examples

The cartridges described below correspond to catalytic modules as described above.

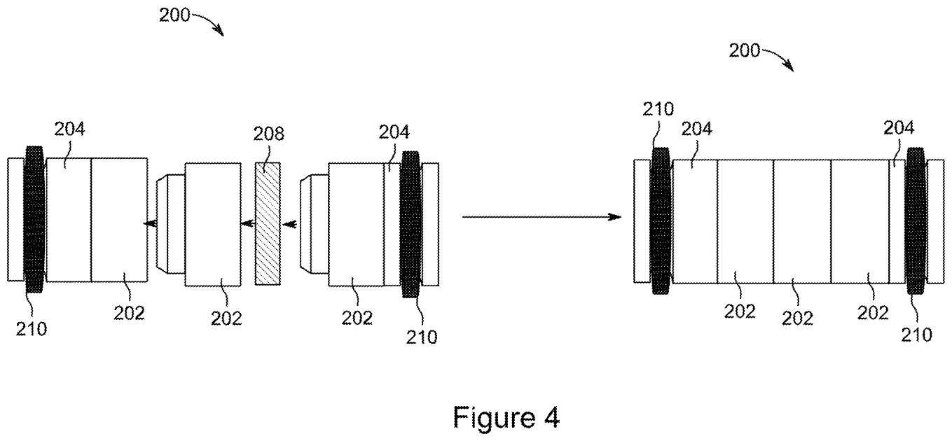

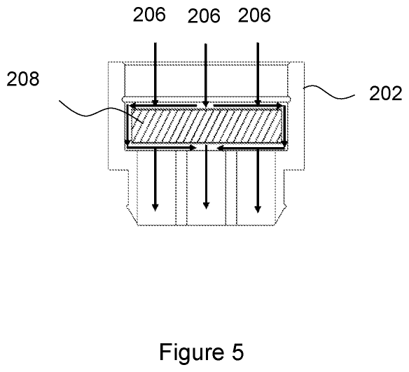

RC-2-1 was a flow-by (FB) type reactor cartridge 200 with 49 catalytic membranes provided with a weight of 0.495 g. The FB cartridge design is made with a series of small interlocking pieces shown in FIG. 4 and FIG. 5. Three interlocking components 202 are stacked between end pieces 204 provided between interlocking components 202. The components 202, 204 were 3D printed from a rigid polyvinylidene fluoride (PVDF) material, but can also be made with other materials compatible to chemistry or using other methods familiar to those skilled in the art. The external diameter of these pieces is 0.355″. The internal diameter is ˜0.290″. The available depth of the click piece once connected with the subsequent piece was 0.060″. The hole diameter in the bottom of the click pieces was 0.070″ for each of the six holes. The channels to allow for flow by are 0.015″ deep and 0.070″ wide. At each end of a constructed cartridge, a unique end piece 204 was used. These end pieces 204 had the same 0.355″ outer diameter and a single internal hole with a diameter of 0.150″. Additionally, each end piece has a groove to allow for an O-ring 210 to be seated. To assemble the cartridge the catalytic membrane 208 is first cut into disks that fit within each piece (FIG. 5). These discs can be cut utilizing a blade, punch, laser, or any other appropriate method. Then one disk is inserted gently into each piece and lightly pushed down until seated at the bottom. Then, the next click piece is press fit into place. This is repeated until all of the catalytic membrane pieces are added. Finally, the unique end pieces are attached, and O-rings 210 fitted to each end (FIG. 5). The finished cartridge is then inserted into the reactor with a PTFE based lubricant to allow for the O-rings 210 to slide if applicable. The fluid 206 enters through the front of the cartridge, hit the surface of the first piece of catalyst membrane 208, flow across this surface to the edge of the disc, flows back across the backside of the disc and then passes through the holes in the plate that supports the disc. This flow pattern is repeated for each piece of catalytic material until it exits the cartridge on the other side. In this design, the flow has designated pathways at each edge of the click piece. This is to try and encourage equal distribution of fluid across the surfaces of the material.

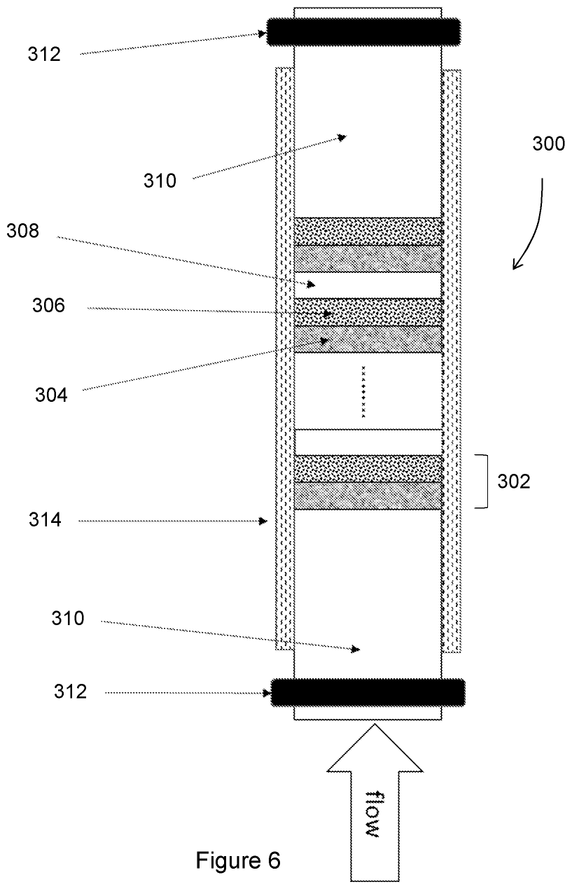

RC-3-1 was a flow through (FT) type cartridge 300 with 41 catalytic membranes provided with a weight of 0.6558 g. With reference to FIG. 6, this cartridge design is made with a series of alternating components. The first component is a spacer 308. The spacer 308 components were 3D printed from PVDF, but can also be made with other materials compatible to chemistry or using other methods familiar to those skilled in the art. These spacers 308 have a thickness of 0.05-0.10″, an outside diameter or 0.345″ and an inner hole diameter of 0.245″. The second main component is an end piece that can be used at either end. The endpieces have a diameter of 0.345″, an inner hole diameter of 0.150″, and a length of 1″. A groove is also present to allow for an O-ring 312 to be seated. The final component of this design is a PVDF shrink tube 314 that goes around the entirety of the cartridge from the first O-ring groove to the last.

To assemble the cartridge 300, first the catalytic membrane is cut into discs 304 the same diameter as the outer diameter of the spacer pieces. These discs can be cut utilizing a blade, punch, laser, or any other appropriate method. Then, a heating implement is used to bond the end of the shrink tube to one of the end pieces. Next, a catalytic disc 304 is placed within the shrink tube 314 and gently pushed down into place against the end piece. Then a spacer 308 or support piece 306 is added to the shrink tube and gently pushed down into place against the catalytic disc. The combination of a catalytic disc 304 and support piece 306 formed a catalytic membrane 302 according to the present invention. This is repeated until all of the catalytic material has been added. The shrink tube 314 is then cut to length and the other end piece is added and bonded using a heating implement. The entire construct is then exposed to heat to allow for the shrink tube to bond to the spacers and catalytic material as best as possible. Afterwards, the cartridge is then placed in an oven at 180° C. for 8 minutes. To complete the construction, each end piece is then treated to additional heat where the shrink tube ends to ensure no leaks are possible and O-rings are added to each end piece.

The finished cartridge (FIG. 6) is then inserted into the reactor with a PTFE based lubricant to allow for the O-rings to slide if applicable. The fluids enter through the front of the cartridge 300, and passes through a reactor chamber 310 and then forced through each layer of catalytic material. The open space within each spacer 308 allows for remixing of these fluid phases before they enter the next piece of catalytic material. This is repeated until the mixture exits the end of the cartridge 300. For this design to work, it is critical that there is no bypass. The fluids cannot be allowed to bypass the O-rings and go around the cartridge 300. The catalytic material must be thoroughly sealed and secured the prevent fluid being able to go around each disc. The shrink tube 314 must be sealed to the edge of each spacer 308 and catalytic disc 304 to prevent fluid from going around any material. If the catalytic material pulls out from between the spacers or cracks, flow through will not occur and flow by performance will be observed.

Reactor cartridges RC-2-1 & RC-3-1 were evaluated as follows. They were placed into the ⅜″ID jacketed stainless-steel tube and connected to the reactor set-up. The temperature setting of the fluid flowing in the jacket of the reactor was set to 20° C. and the back pressure regulator was set to 75 psi (517 kPa). The RC-2-1 was evaluated with inlet stock solution feed flow rate of 1 g/min, 2.5 g/min, and finally at 5 g/min. RC-3-1 the liquid flow rate of 1 and 2.5 g/min. The inlet flow of H₂ was adjusted accordingly to maintain 6 H₂ equivalents. The reactor with RC-3-1 can maintain high production yields of aniline at 2.5 g/min stock solution feed for at least 180 min. The results of the tests are summarized in Table 4 below. Depending on the flow rates, the pressure drop per membrane is 0.04 psi (0.3 kPa)/membrane for RC-2-1, and in the range of ˜1 psi (6.9 kPa)/membrane at 1 g/min and ˜1.7 psi (11.7 kPa)/membrane at 2.5 g/min inlet flow rate for RC-3-1.

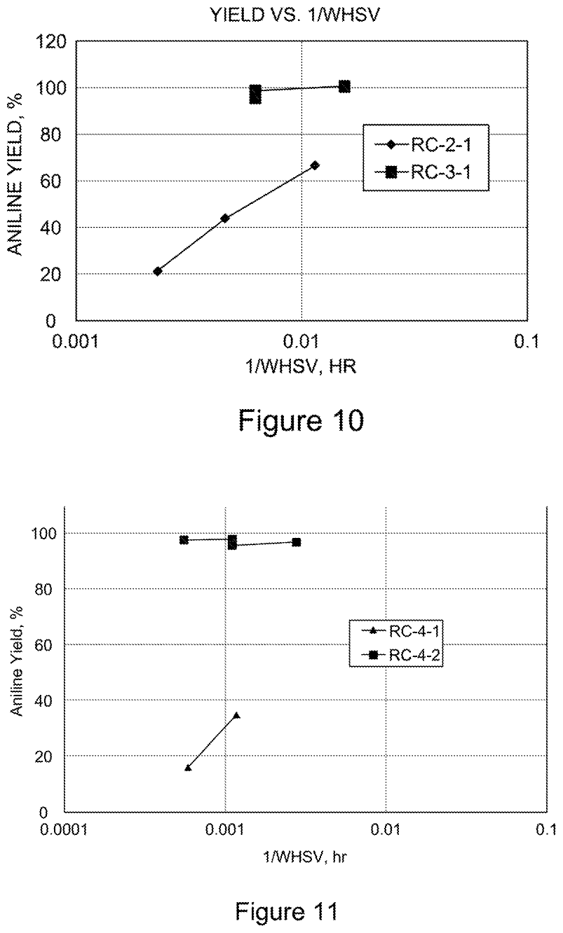

The yields as a function of inverse WHSV for RC-2-1 and RC-3-1 are compared in FIG. 10.

RC-4-1 was a FB-type reactor cartridge with 50 catalytic membranes provided with a weight of 0.423 g. It was made in the same manner as RC-2-1. RC-4-2 was a FT-type reactor cartridge with 35 catalytic membranes with a weight of 0.408 g. It was made in the same manner as RC-3-1.

Reactor cartridges RC-4-1 & RC-4-2 were evaluated as follows. They were placed into the ⅜″ID jacketed stainless-steel tube and connected to the flow reactor set-up. The temperature setting of the fluid flowing in the jacket of the reactor was set to 20° C. and the back pressure regulator was set to 75 psi (517 kPa). The inlet flow of H₂ was adjusted accordingly to maintain 6 H₂ equivalents. RC-4-1 was evaluated at inlet stock feed flow rates of 2.5 and 5 g/min, while RC-4-2 was evaluated at 1, 2.5 and 5 g/min. The results are summarized in Table 4. Depending on the inlet flow rate the pressure drop per membrane for RC-4-2 was between ˜2.5 psi (17.2 kPa)/membrane and 6.4 psi (44 kPa)/membrane.

The yields as a function of inverse WHSV for RI-4-1 and RI-4-2 are compared in FIG. 11. RC-5-1 was a FB-type reactor cartridge with 7 catalytic membranes with a weight of 0.175 g. It was made the same way as RC-2-2. RC-5-2 was a FT-type reactor cartridge with 4 catalytic membranes with a weight of 0.170 g. It was made the same way as RC-3-1.

RC-5-3 was a FT-type cartridge with a single membrane that weigh about 0.269 gr. It was made as follows: A square piece about 21×21 mm was cut from the catalytic membrane material. A 40×40 mm square was cut from a PVDF spacer having thickness similar to that of the catalytic membrane. At the centre of this PVDF spacer, a square piece 21×21 mm was cut out and discarded. Similarly, two 40×40 mm squares were cut from a PVDF sheet having thickness 0.003″, but this time, for both squares, a square piece 18×18 mm in the centre was cut out and discarded. The square piece of catalytic membrane was placed in the square hole of the PVDF spacer piece. Then one of the two 0.003′ PVDF sheet pieces was placed on top, while the other one was placed at the bottom. Those two PVDF sheets were properly aligned with the PVDF spacer so that their 18×18 mm opening is in the center of the 21×21 mm catalytic membrane. A heat weld process was used to weld both 0.003″ PVDF pieces and the catalytic membrane with a 1 mm wide heat weld located just outside the 18×18 mm center area of the catalytic membrane. The heat welding process was repeated once more, this time welding the PVDF spacer and both 0.003″ PVDF pieces with a 2 mm wide heat weld located just outside the 21×21 mm catalytic membrane. Details of the material configuration and heat welding of the FT-type 2 cartridge is shown on FIG. 9. Holes, grooves, and other features needed to install the cartridge in the multi-layer reactor are not shown in this figure.

Reactor cartridges RC-5-1 & RC-5-2 were evaluated as follows. Each one was placed into the ⅜″ID jacketed stainless-steel tube and connected to the flow set-up. The temperature setting of the fluid flowing in the jacket of the reactor was set to 20° C. and the back pressure regulator was set to 75 psi (517 kPa). The inlet flow of H₂ was adjusted accordingly to maintain 6 H₂ equivalents. RC-5-3 was evaluated at room temperature using the modular reactor shown in FIG. 8 (described below). RC-5-3 was sandwiched between two cartridges made with an inert porous PTFE layer (Porex PM5010 with thickness 0.039″) instead of a catalytic membrane. The back pressure regulator was set to 80 psi (551.6 kPa) and the inlet flow of H₂ was adjusted accordingly to maintain 6 H₂ equivalents.

The results are summarized in Table 4. The pressure drop per membrane is in the range of ˜0.85 to ˜3.85 psi (˜5.9 to ˜26.5 kPa)/membrane for RC-5-1, ˜5.75 to 21.5 psi (˜39.6 kPa to ˜148.2 kPa)/membrane for RC-5-2, and ˜2 to ˜11 psi for RC-5-3. Pressure drop per membrane is estimated by dividing the overall pressure drop with the number of catalytic membrane layers in each reactor.

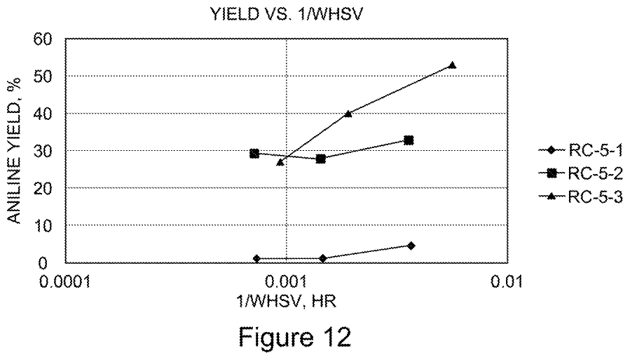

FIG. 12 compares the aniline yields as a function of 1/WHSV of cartridges RC-5-1, RC-5-2 and RC-5-3.

RC-6-1 was a FT-type reactor cartridge with 4 catalytic membranes with a weight of 0.163 g. It was made the similar way as RC-3-1. In RC-6-1 each membrane was supported by a porous PTFE layer (Porex PM5010 with thickness 0.039″) between the catalytic membrane in addition to the spacer disk. The flow exiting the end piece at the inlet enters the catalytic membrane then goes through the PTFE layer and then enters the spacer ring, before it enters the next catalytic membrane.

RC-6-2 was a FT-type reactor cartridge with 4 catalytic membranes with a weight of 0.174 g. It was made in a similar way as RC-3-1. However, this cartridge had no spacer rings and each catalytic membrane was supported by a porous PTFE layer (Porex PM5010 with thickness 0.039″) as for RC-6-1.

Reactor cartridges RC-6-1, RC-6-2 were evaluated and are compared to insert RC-5-2. Each insert was placed into the ⅜″ID jacketed stainless-steel tube and connected to the flow set-up. Each reactor insert was initially evaluated with inlet stock solution feed flow rate of 1 g/min, then at 2.5 g/min and then at 5 g/min. The inlet flow of H₂ was adjusted accordingly to maintain 6 H₂ equivalents. Results for all three cartridges are summarized and compared in Table 4. The pressure drop per membrane/porous support pair is in the range of ˜11 to ˜24 psi (˜75.8 kPa to ˜165.5 kPa)/pair for RC-6-1 and ˜5.75 to 21.5 psi (˜39.6 to 148.2 kPa)/pair for RC-6-2.

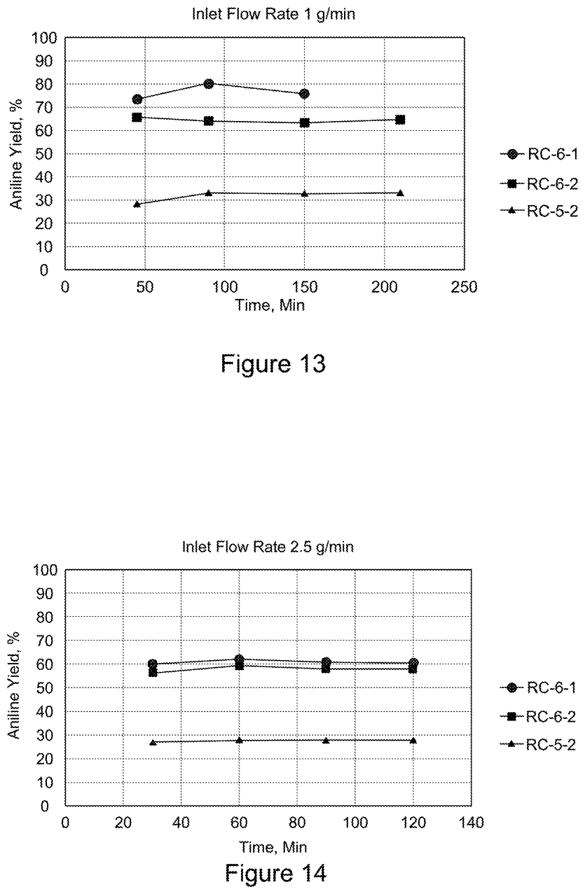

FIG. 13 compares the aniline yields as a function of time on stream for RC-6-1, RC-6-2, and RC-5-2. The stock solution feed flow rate was 1 g/min and the H₂ inlet flow was adjusted accordingly to maintain 6 H₂ equivalents.

FIG. 14 compares the aniline yields as a function of time on stream for RC-6-1, RC-6-2, and RC-5-2. The stock solution feed flow rate was 2.5 g/min and the H₂ inlet flow was adjusted accordingly to maintain 6 H₂ equivalents.

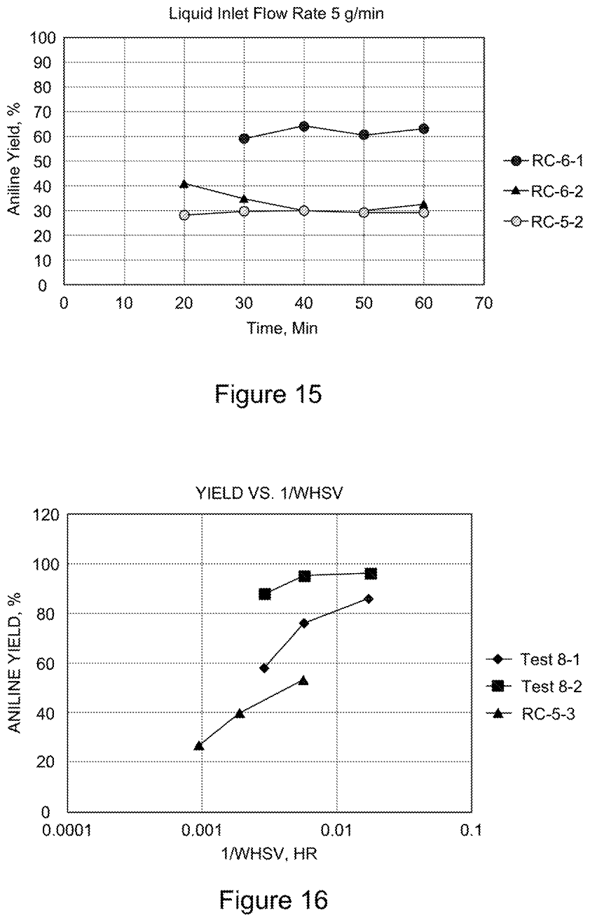

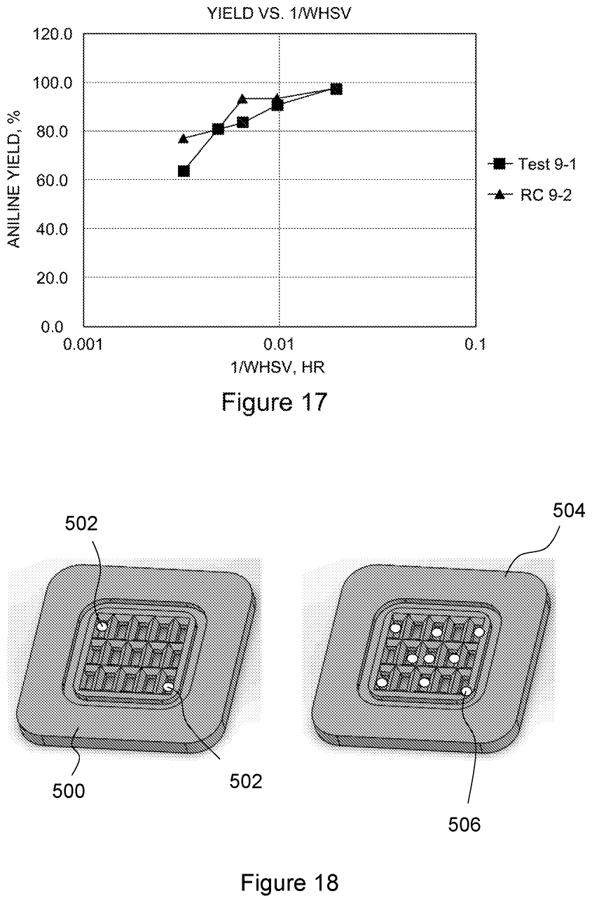

FIG. 15 compares the aniline yields as a function of time on stream for RC-6-1, RC-6-2, and RC-5-2. The stock solution feed flow rate was 5 g/min and the H₂ inlet flow was adjusted accordingly to maintain 6 H₂ equivalents.

RC-7-1 was a FT-type reactor with 34 catalytic membranes with a weight of 0.3544 g. It was made the same way as RC-3-1.

The reactor cartridge RC-7-1 was placed into the ⅜″ID jacketed stainless steel tube and connected to the flow set-up. The temperature setting of the fluid flowing in the jacket of the reactor was set to 20° C. and the back pressure regulator was set to 75 psi (517.1 kPa). The H₂ equivalents for all stock solution flow rates fed to the reactor were equal to 6. The results are summarized in Table 4. Dividing the total pressure drop with the number of catalytic membrane disks in the reactor indicates that the pressure drop per membrane was in the range of ˜4.6 to 6.3 psi (˜31.7 to 43.4 kPa)/membrane.

Additional cartridges of RC-5-3 type were prepared and evaluated as follows. In test 8-1 three cartridges were loaded in the Multifunctional Layer Reactor (FIG. 4). Furthermore, a cartridge with an Inert Porous Layer (Porex PM5010 PTFE with thickness 0.039″) was placed before and after the three cartridges. In test 8-2, the same three RC-5-3 cartridges were also loaded to the Multifunctional Layer Reactor, however this time a cartridge with an Inert Porous Layer (Porex PM5010 PTFE with thickness 0.039″) was also after each RC-5-3 cartridge, so that the flow exiting a cartridge first passes through the inert porous layer, before it enters the next catalytic membrane.

The total weight of the catalytic membranes of the three cartridges is about 0.818 g.

Each reactor insert was initially evaluated at room temperature and a back pressure regulator setting of 80 psi (551.6 kPa), with inlet stock solution feed flow rate of 1 g/min, then at 3 g/min and then at 6 g/min. The inlet flow of H₂ was adjusted accordingly to maintain 6 H₂ equivalents.

Results tests 8-1 and 8-2 are summarized and compared in Table 4. FIG. 16 compares the aniline yield vs. 1/WHSV using a single cartridge RC-5-3 (Example 5), and test 8-1 and 8-2.

RC-9 were FT cartridges made the same way as cartridge RC-5-3. The following tests were conducted:

Test 9-1: Three RC-9 cartridges were loaded in the modular reactor 400. The total weight of the catalytic membranes 428 of the three RC-9 cartridges (catalytic layers 416) is about 0.966 gr. A single inert porous layer made with PTFE (Porex PM5010 with thickness 0.039″) was placed before and at the end of all three cartridges. Evaluation took place at room temperature and a back pressure regulator setting of 80 psi (551.6 kPa). The test was repeat four times: The first & second time the inlet stock solution feed flow rate was 1, 3, and 6 g/min. The third and fourth time the inlet stock solution feed flow rate was 1, 2, 4, and 6 g/min. In all cases the inlet flow of H₂ was adjusted accordingly to maintain 6 H₂ equivalents.

Test 9-2: The same three RC-9 cartridges were loaded in the modular reactor 400, however this time a cartridge with an inert porous layer made with PTFE (Porex PM5010 with thickness 0.039″) was also placed between each cartridge, so that the flow exiting a cartridge first passes through the POREX support layer, before it enters the next catalytic membrane. Evaluation took place at room temperature and a back pressure regulator setting of 80 psi (551.6 kPa). The test was repeat three times: the first time the inlet stock solution feed flow rate was 1, 3, and 6 g/min. The second and third time the inlet stock solution feed flow rate was 1, 2, 4, and 6 g/min. The inlet flow of H₂ was adjusted accordingly to maintain 6 H₂ equivalents. Results tests 9-1 & 9-2 are summarized in Table 4.

TABLE 4
Comparison of different reactors comprising catalytic membranes of the examples.

| | | | | | Flow | Pressure | 1/ | |
|---|---|---|---|---|---|---|---|---|
| | | Number of | Diameter, | | rate, | drop, | WHSV, | |
| Reactor | Example | membranes | mm | Time | g/min | psi | hr | Yield, % |
| RC-2-1 | 1 | 49 | 7.4 | 75 | 1 | 2 | 0.0114 | 66.3 |
| | | | | 30 | 2.5 | 2 | 0.0046 | 43.6 |
| | | | | 15 | 5 | 2 | 0.0023 | 21 |
| RC-3-1 | 2 | 41 | 8.8 | 45 | 1 | 42 | 0.0155 | 85.9 |
| | | | | 90 | 1 | 43 | 0.0155 | 100.7 |
| | | | | 36 | 2.5 | 54 | 0.0062 | 98.5 |
| | | | | 60 | 2.5 | 52 | 0.0062 | 95.4 |
| | | | | 120 | 2.5 | 52 | 0.0062 | 98.5 |
| | | | | 180 | 2.5 | 51 | 0.0062 | 99 |
| RC-4-1 | 3 | 50 | 7.4 | 30 | 2.5 | <1 | 0.0012 | 34.9 |
| | | | | 15 | 5 | <1 | 0.0006 | 16 |
| RC-4-2 | 4 | 35 | 8.8 | 90 | 1 | 87 | 0.0027 | 96.7 |
| | | | | 72 | 2.5 | 154 | 0.0010 | 97.4 |
| | | | | 18 | 5 | 225 | 0.00055 | 97.6 |
| RC-5-1 | 5 | 7 | 7.4 | 150 | 1 | 6 | 0.00365 | 4.5 |
| | | | | 120 | 2.5 | 17 | 0.00146 | 1.2 |
| | | | | 60 | 5 | 27 | 0.00073 | 1.2 |
| RC-5-2 | 5 | 4 | 8.8 | 150 | 1 | 19 | 0.00355 | 32.8 |
| | | | | 120 | 2.5 | 35 | 0.00142 | 27.9 |
| | | | | 60 | 5 | 95 | 0.00071 | 29.3 |
| RC-5-3 | 5 | 1 | 21 × 21 | | 1 | 2 | 0.0056 | 53 |
| | | | square | | | | | |
| | | | | | 3 | 6 | 0.00189 | 40 |
| | | | | | 6 | 11 | 0.00933 | 28 |
| RC-6-1 | 5 | 4 | 8.8 | 150 | 1 | 46 | 0.0034 | 75.8 |
| | | | | 120 | 2.5 | 55 | 0.00136 | 60.3 |
| | | | | 60 | 5 | 96 | 0.00068 | 63.8 |
| RC-6-2 | 6 | 4 | 8.8 | 150 | 1 | 23 | 0.00362 | 63.3 |
| | | | | 120 | 2.5 | 62 | 0.00145 | 57.9 |
| | | | | 60 | 5 | 86 | 0.00072 | 32.7 |
| RC-7-1 | 7 | 34 | 8.8 | 45 | 1 | 162 | 0.000492 | 75.7 |
| | | | | 90 | 1 | 155 | 0.000492 | 76.3 |
| | | | | 36 | 2.5 | 213 | 0.000197 | 75.4 |
| RC-5-3 | 8-1 | 3 | 21 × 21 | | 1 | 2 | 0.017042 | 86 |
| | | | square | | | | | |
| | | | | | 3 | 6 | 0.005681 | 76 |
| | | | | | 6 | 11 | 0.00284 | 58 |
| RC-5-3 | 8-2 | 3 | 21 × 21 | | 1 | 2 | 0.017042 | 96 |
| | | | square | | | | | |
| | | | | | 3 | 6 | 0.005681 | 95 |
| | | | | | 6 | 11 | 0.00284 | 88 |
| RC-9 | 9-1 | 3 | 21 × 21 | 15 | 1 | 2 | 0.02013 | 97.4 |
| | | | square | | | | | |
| | | | | 8 | 2 | 4 | 0.01001 | 90.9 |
| | | | | 5 | 3 | 5 | 0.00671 | 83.8 |
| | | | | 4 | 4 | 7 | 0.00503 | 81.2 |
| | | | | 3 | 6 | 10 | 0.00335 | 63.6 |
| | 9-2 | 3 | 21 × 21 | 15 | 1 | 2 | 0.02013 | 97.6 |
| | | | square | | | | | |
| | | | | 8 | 2 | 4 | 0.01001 | 93.4 |
| | | | | 5 | 3 | 4 | 0.00671 | 93.4 |
| | | | | 4 | 4 | 7 | 0.00503 | 80.6 |
| | | | | 3 | 6 | 9.5 | 0.00335 | 77.2 |
| RC-11 | 11-1 | 1 | 21 × 21 | 15 | 1 | 1 | 0.00629 | 46.1 |
| | | | square | | | | | |
| | | | | 5 | 3 | 3 | 0.00210 | 31.5 |
| | | | | 3 | 6 | 5 | 0.00105 | 15.5 |
| | 11-2 | 1 | 15 × 15 | 30 | 0.5 | 0 | 0.00617 | 42.9 |
| | | | square | | | | | |
| | | | | 10 | 1.5 | 3 | 0.00206 | 27.8 |
| | | | | 6 | 3 | 6 | 0.00103 | 15.7 |

In order to demonstrate the advantages of the catalytic membranes of the examples, comparison systems were tested for the reduction of nitrobenzene to aniline and the reaction conditions were as follows: Temperature=20° C., pressure=517.1 kPa (75 psi), Nitrobenzene concentration at feed ˜0.21M in ethanol, H₂ equivalence at feed=6, and the results are shown in Table 5 below.

TABLE 5
Comparative examples performance for reduction of aniline reaction

| | | Liquid | | | Mass | Mass |
|---|---|---|---|---|---|---|
| | | solution | 1/ | | of | of Pd |
| Comparative | Catalyst | feed flow | WHSV, | Yield, | form in | in |
| Example | form | rate, g/min | hr | % | reactor | reactor |
| 1 | Pd/Al₂O₃ | 10 | 0.003982 | 10.7 | 15.77 | 0.07885 |
| | pellet | 5 | 0.007965 | 20.9 | | |
| | | 2.5 | 0.015929 | 30.4 | | |
| | | 1 | 0.039823 | 34 | | |
| 2 | Pd/C | 2.5 | 0.004394 | 30.4 | 4.35 | 0.02175 |
| | monolith | 1 | 0.010985 | 70.8 | | |

The catalytic pellets (STREM, 46-1920 Lot #29363800) or the monolith ((ACM-Pd-80-101H purchased from Applied Catalysts) were placed into the reaction chamber which was a ⅜ ID tube. In the case of the pellets the reactants flowed around the pellets and in the case of the monolith the reactants flowed through the monolith channels. Accordingly, the example catalytic membranes provide greatly increased product yields when compared to alternative catalytic systems.

An aluminum heat exchange module was placed between two measurement modules 500, 504 in a modular reactor. The measurement module 500 close to the inlet had two thermocouples 502 placed at the corners of the square channel. The outlet measurement module 504 had nine thermocouples (one at each corner and five making a cross sign in the center, for example 506). The locations of thermocouples are depicted in FIG. 18.

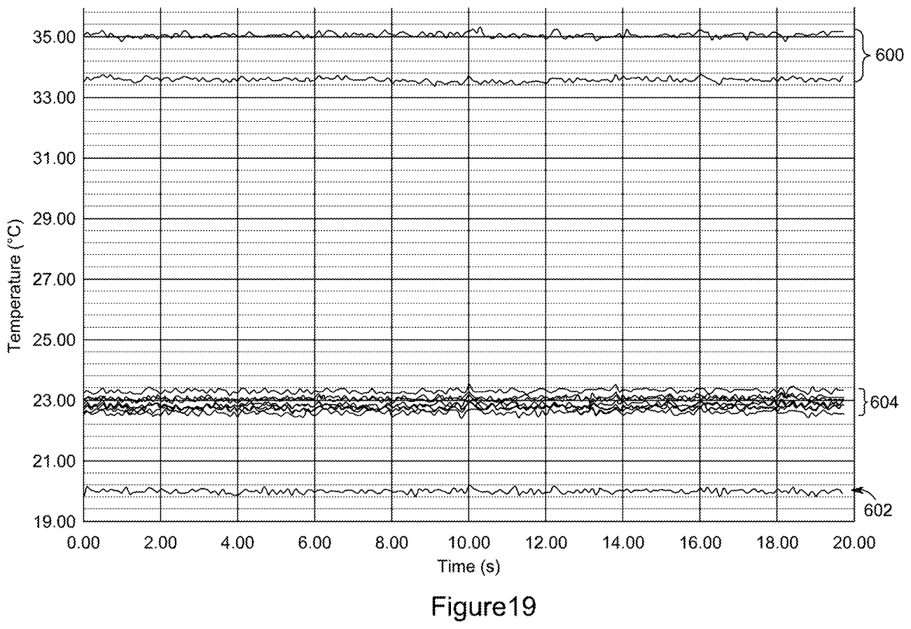

10 ml/min of water were fed to the reactor pre-heated to ˜35° C. (hot feed temperature 600). The same time 100 ml/min of water coolant at ˜20° C. (cold feed temperature 602) were fed to the heat exchange module. The nine thermocouples at the outlet measurement module recorded a uniform temperature of ˜23±˜0.5° C. (FIG. 19) (outlet temperature 604).

Reactor cartridge RC-11-1 was made the same way as cartridge RC-5-3, using catalytic membrane 5. The weight of the ˜21.2 mm×˜21.2 mm square piece of CM8 was ˜0.302 gr The square area exposed to flow was about 18 mm×18 mm.

Reactor cartridge RC-11-2 was also made the same way as cartridge RC-5-3, using catalytic membrane 5. However the square piece of CM8 was 15 mm×15 mm that weigh about 0.148 gr and exposes a square of about 12.73 mm×12.73 mm to the flow. Table 6 details the relevant parameters of RC-11-1 and RC-11-2.

TABLE 6
Example membrane comparison for reactor
cartridges of different dimensions.

| | Total | Total | Exposed |
|---|---|---|---|
| Reactor | Membrane | Membrane | Membrane |
| Cartridge | mass (g) | Area (cm²) | Area (cm²) |
| RC-11-1 | 0.302 | 449 | 324 |
| RC-11-2 | 0.148 | 225 | 162 |

Using RC-11-1 and RC-11-2 the following tests were performed.

Test 11-1: The single RC-11-1 cartridge was loaded in the modular reactor. A single inert porous layer made with PTFE (Porex PM5010 with thickness 0.039″) was placed before and after the cartridge. Evaluation took place at room temperature and a back pressure regulator setting of 80 psi (551.6 kPa), with inlet stock solution feed flow rate of 1 g/min, then at 3 g/min and then at 6 g/min. The inlet flow of H₂ was adjusted accordingly to maintain 6 H₂ equivalents.

Test 11-2: The single RC-11-2 cartridge was loaded in the modular reactor. A single inert porous layer made with PTFE (Porex PM5010 with thickness 0.039″) was placed before and after the cartridge. Evaluation took place at room temperature and a back pressure regulator setting of 80 psi (551.6 kPa), with inlet stock solution feed flow rate of 0.5 g/min, then at 1.5 g/min and then at 3 g/min. The inlet flow of H₂ was adjusted accordingly to maintain 6 H₂ equivalents.

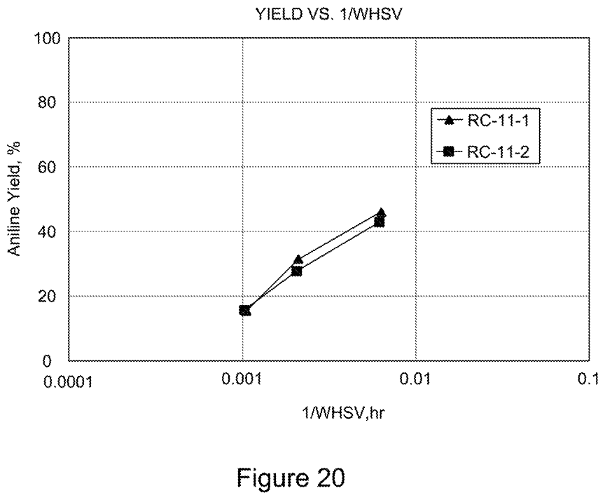

The results for these two tests are summarize and compared below in Table 7 and FIG. 20.

TABLE 7
Results of reactions for example reactor cartridges RC-11-1 and RC-11-2.

| | RC-11-1 | | | | RC-11-2 | | | |
|---|---|---|---|---|---|---|---|---|
| | Stock | | | | Stock | | | |
| | Solution | | | | Solution | | | |
| Superficial | flow | | 1/ | Aniline | flow | | 1/ | Aniline |
| Velocity | rate, | Pressure | WHSV, | Yield, | rate, | Pressure | WHSV, | Yield, |
| (cm/min) | g/min | drop, psi | hr | % | g/min | drop, psi | hr | % |
| 0.004 | 1 | 1 | 0.00629 | 46.1 | 0.5 | 0 | 0.00617 | 42.9 |
| 0.012 | 3 | 3 | 0.00210 | 31.5 | 1.5 | 3 | 0.00206 | 27.8 |
| 0.023 | 6 | 5 | 0.00105 | 15.5 | 3 | 6 | 0.00103 | 15.7 |

Superficial Velocity = ((mL/min of Liquid phase/Active Area of cartridge (cm²))
1 pound per square inch (psi) = 6.895 kilo Pascals (kPa)

While there has been hereinbefore described approved embodiments of the present invention, it will be readily apparent that many and various changes and modifications in form, design, structure and arrangement of parts may be made for other embodiments without departing from the invention and it will be understood that all such changes and modifications are contemplated as embodiments as a part of the present invention as defined in the appended claims.

1. A catalytic membrane comprising at least one porous catalytic fluoropolymer film comprising catalyst particles enmeshed within a fluoropolymer matrix, wherein the catalytic membrane is configured to be suitable for use in a flow through reactor where substantially all of the reactant flowing through the reactor flows through the pores of the porous catalytic fluoropolymer film.

2. The catalytic membrane of claim 1, wherein the catalytic membrane has an air flow resistivity of from about 1×10⁹ Pa s/m² to about 1×10⁴ Pa s/m².

3. The catalytic membrane of claim 1, wherein the catalytic membrane has a total specific pore volume of from 0.4 cc/g to 2.5 cc/g.

4. The catalytic membrane of claim 1, wherein the at least one porous catalytic fluoropolymer film comprises a fluoropolymer matrix, optionally wherein the fluoropolymer matrix comprises a fibrillated microstructure.

5. (canceled)

6. The catalytic membrane of claim 4, wherein the fluoropolymer matrix comprises polytetrafluoroethylene (PTFE).

7. The catalytic membrane of claim 4, wherein the fluoropolymer is an expanded fluoropolymer, optionally wherein the fluoropolymer is expanded PTFE (ePTFE).

8. (canceled)

9. The catalytic membrane of claim 1, wherein the catalytic membrane has a thickness of from about 100 μm to about 2000 μm.

10. The catalytic membrane of claim 1, wherein the catalytic membrane has a Brunauer, Emmett and Teller (BET) specific surface area of from about 10 m²/g to about 1250 m²/g.

11. The catalytic membrane of claim 1, wherein the catalytic membrane has a bulk density of from about 0.05 g/cm³ to about 3.0 g/cm³.

12. The catalytic membrane of claim 1, further comprising a support layer.

13. (canceled)

14. The catalytic membrane of claim 1, wherein the catalytic membrane has a yield strength of at least 0.1 MPa.

15. The catalytic membrane of claim 1, wherein the pressure drop across the catalytic membrane during use is from 0.069 kPa per membrane to 2068 kPa per membrane.

16. A catalytic module comprising at least one catalytic membrane according to claim 1, spanning an aperture defined in a support.

17. A modular reactor comprising at least one input module, at least one output module and at least one catalytic module according to claim 16, wherein the modular reactor is configured such that fluid may flow from the at least out input module to the at least one output module through the catalytic membranes of the at least one catalytic module.

18. The modular reactor according to claim 17 comprising at least one heat exchange module.

19. The modular reactor according to claim 17 comprising a spacer module.

20. The modular reactor according to claim 17 comprising a measurement module.

21. A reactor for continuous flow reactions, the reactor comprising a reaction chamber, an inlet, an outlet and a catalytic membrane according to claim 1 that spans the reaction chamber, wherein the inlet and outlet are in fluid communication with the reaction chamber such that during use fluid flows from the inlet to the outlet via the reaction chamber, wherein substantially all fluid flowing from the inlet to the outlet passes through the catalytic membrane, optionally wherein a seal is provided at the interface between the catalytic membrane and the interior surface of the reaction chamber.

22. (canceled)

23. The reactor according to claim 21, further comprising a plurality of catalytic membranes comprising at least one porous catalytic fluoropolymer film comprising catalyst particles enmeshed within a fluoropolymer matrix provided in series along the length of at least a portion of the reaction chamber,
wherein the catalytic membrane is configured to be suitable for use in a flow through reactor where substantially all of the reactant flowing through the reactor flows through the pores of the porous catalytic fluoropolymer film,
optionally wherein the reactor further comprises a spacer located between at least two adjacent catalytic membranes within the plurality of catalytic membranes,
further optionally wherein the spacer is configured to separate adjacent catalytic membranes within the plurality of catalytic membranes without substantially impeding the flow of fluid between the adjacent catalytic membranes during use.

24. (canceled)

25. (canceled)

26. The reactor of claim 23, wherein the spacer comprises an aperture to all allow to flow between the adjacent catalytic membranes of the plurality of catalytic membranes during use.
